(19) United States
(12) Patent Application Publication
(10) Pub. No.: US 2026/0254751 A1
(43) Pub. Date: Aug. 27, 2026

(54) MULTIPATH TRANSMISSION IN WIRELESS NETWORKS

(71) Applicant: City University of Hong Kong, Kowloon (HK)

(72) Inventors: Jiajun Chen, Kowloon (HK); Chi Wan Sung, Kowloon (HK); Wing Ming Eric Wong, Kowloon (HK)

(21) Appl. No.: 19/061,235

(22) Filed: Feb. 24, 2025

(51) Int. Cl. H04L 45/24; H04L 5/00; H04W 40/02; H04W 40/14

(52) U.S. Cl. CPC H04L 45/24; H04L 5/0048; H04W 40/023; H04W 40/14

(57) ABSTRACT

There is provided a method for multipath transmission in wireless networks, which includes receiving an input packet at a source node, encoding the input packet into multiple coded sub-packets by applying codes for multipath transmission, and transmitting the multiple coded sub-packets to a receiving end via multiple paths, wherein each path i∈{1, . . . , N}.

### TECHNICAL FIELD

The present invention relates to methods and systems for multipath transmission in wireless networks.

### BACKGROUND

In recent years, with the rapid development of new applications and services, such as automated driving, remote robotics and telemedicine, real-time streams from sensors is required for transmission with low latency and high reliability. These strict requirements create unprecedented research challenges to wireless network design. In the fifth-generation (5G) and future sixth-generation (6G) mobile wireless networks, ultra-reliable and low-latency communications (URLLCs) plays a central role to support various emerging mission-critical applications [1]-[3]. Different approaches have been proposed to reduce transmission delay, e.g., shorter transmission time intervals (TTI) and faster uplink scheduling strategies like grant-free access [4]. Even though the physical-layer technology for 5G can achieve low transmission delay [5], the stochastic delays in upper networking layers, such as queuing delay, processing delay and packet loss, are still key bottlenecks in achieving low end-to-end delay [3]. Hence, cross-layer optimization is required [6]-[8].

### SUMMARY OF THE INVENTION

The emerging mission-critical applications such as automated driving and remote robotics require mobile wireless networks to provide low latency and high reliability. Exemplary embodiments of the invention focus on the cross-layer design for coded multipath transmission in wireless networks, where both queue state information and channel state information are considered to reduce delay and packet loss. The latency-sensitive premium traffic is mission-critical, and each traffic packet is required to reach the user via multiple base stations before a tight deadline. To reduce the packet loss due to queue blocking or channel fading, some embodiments of the invention apply MDS coding to the multipath transmission at the cost of slightly increasing the communication overhead. For homogeneous systems, some embodiments of the invention derive the optimal code parameter under the assumption of independent traffic at multiple paths. For heterogeneous systems with traffic dependency at multiple paths, some embodiments of the invention propose greedy and greedy+algorithms for load allocation. Simulation results show that the proposed greedy+algorithm outperforms equal allocation in most cases.

According to a first aspect of the invention, there is provided a method for multipath transmission in wireless networks, which includes receiving an input packet at a source node, encoding the input packet into multiple coded sub-packets by applying codes for multipath transmission, and transmitting the multiple coded sub-packets to a receiving end via multiple paths, wherein each path i∈{1, . . . , N}.

In some embodiments, the codes for multipath transmission may be (n, k) maximum distance separable (MDS) codes, and the step of encoding the input packet may include applying the (n, k) MDS codes at the source node.

In some embodiments, the step of encoding the input packet may further includes dividing the input packet into k sub-packets, wherein the input packet has a constant packet size L and each sub-packet has a packet size of L/k, and encoding the k sub-packets into n coded sub-packets, wherein each coded sub-packet has a packet size of L/k.

In some embodiments, the multiple paths may be multiple base stations, and the n coded sub-packets may be assigned to all the base stations.

In some embodiments, the method may further include determining, by the receiving end that the original input packet can be successfully decoded once the receiving end receives any k coded sub-packets within a time limit T₀.

In some embodiments, the step of encoding the input packet may further include code design and load allocation to minimize loss probability based on queue state information and channel state information, wherein if the input packet fails to be received by the receiving end within a time limit, it is considered a delivery failure and the corresponding probability is the loss probability.

In some embodiments, the code design and load allocation may include configuring a cross-layer model for each path by using a network layer based on a queue model to process arriving packets and a link layer based on a wireless erasure channel with constant erasure probability eᵢ.

In some embodiments, the code design and load allocation may include determining code parameters (n, k) for the MDS codes and allocation vector n a (n₁, . . . , n_{N}), where ∥n∥₁=n≥k≥1 to minimize the loss probability.

In some embodiments, if all the paths have the same characteristics, the code design and load allocation may include using the code parameters (n=N, k) for the MDS codes and assigning each of the N coded sub-packets to each path.

In some embodiments, the loss probability may be provided as:

$${P}_{loss} ( k ) = {\sum }_{i = N - k + 1}^{N} ( \begin{matrix}N \\ i\end{matrix} ) {( B ( k ) + ( 1 - B ( k ) ) {q}^{k} )}^{i} {( 1 - B ( k ) - ( 1 - B ( k ) ) {q}^{k} )}^{N - i} ,$$

$$where q = {e}_{i}^{\frac{{RT}_{0}}{L}} .$$

In some embodiments, if all the paths do not have the same characteristics, the code design and load allocation may include, given an (n, k) MDS code, determining load allocation vector n by greedy-based algorithm that assigns n sub-packets sequentially to the paths in an iterative manner.

In some embodiments, at each iteration, the greedy-based algorithm may assign a sub-packet to path j with the largest value of sⱼ (nⱼ), where

$${s}_{j} ( {n}_{j} ) {=}^{Δ} \{ \begin{matrix}( 1 - {\overline{B}}_{j} ) {Ω}_{j} ( 1 ) , & if {n}_{j} = 0 , \\ \frac{{Ω}_{j} ( {n}_{j} + 1 )}{{Ω}_{j} ( {n}_{j} )} , & if 1 \leq {n}_{j} \leq {X}_{0} , \\ 0 , & if {n}_{j} \geq {X}_{0} ,\end{matrix}$$

$$and {X}_{0} {=}^{Δ} min \{ k , ⌊ \frac{{kRT}_{0}}{L} ⌋ \} ,$$

and suppose j* is selected,

$${j}^{*} = arg {max}_{j} {s}_{j} ( {n}_{j} ) ,$$

with ties broken arbitrarily.

In some embodiments, the assignment of the first k sub-packets may be the same as the greedy-based algorithm, and starting from iteration k+1, advanced greedy-based algorithm may assign a sub-packet to path j with the largest value of

$${s}_{j}^{+} ( n ) ,$$

where

$${s}_{j}^{+} ( n ) {=}^{Δ} \{ \begin{matrix}( 1 - {\overline{B}}_{j} ) {Ω}_{j} ( 1 ) Pr \{ {S}_{- j} = k - 1 \} , & if {n}_{j} = 0 , \\ {Ω}_{j} ( {n}_{j} + 1 ) Pr \{ {S}_{- j} = k - {n}_{j} - 1 \} , & if 1 \leq {n}_{j} \leq {X}_{0} , \\ 0 , & if {n}_{j} \geq {X}_{0} ,\end{matrix}$$

and S₋ⱼ≙Σ_{i≠j}Nᵢ(nᵢ), and suppose j* is selected,

$${j}^{*} = arg {max}_{j} {s}_{j} ( {n}_{j} ) ,$$

with ties broken arbitrarily.

In some embodiments, after each iteration, the following update may be made:

$${n}_{{j}^{*}} ← {n}_{{j}^{*}} + 1 ,$$

and the procedure repeats until all sub-packets have been assigned.

According to a second aspect of the invention, there is provided a system for multipath transmission in wireless networks, which includes one or more processors, and memory storing one or more programs configured to be executed by the one or more processors, the one or more programs including instructions for performing or facilitating performing of the method of the first aspect.

According to a third aspect of the invention, there is provided a non-transitory computer-readable storage medium storing one or more programs configured to be executed by one or more processors, the one or more programs including instructions for performing or facilitating performing of the method of the first aspect.

Other features and aspects of the invention will become apparent by consideration of the detailed description and accompanying drawings. Any feature(s) described herein in relation to one aspect or embodiment may be combined with any other feature(s) described herein in relation to any other aspect or embodiment as appropriate and applicable.

### BRIEF DESCRIPTION OF DRAWINGS

Embodiments of the invention will now be described, by way of example, with reference to the accompanying drawings in which:

FIG. 1 shows a system model according to an embodiment of the invention.

FIG. 2 shows blocking probabilities in homogeneous systems.

FIG. 3 shows blocking probabilities in homogeneous systems.

FIG. 4 shows blocking probabilities in the heterogeneous system of Scenario 1.

FIG. 5 shows blocking probabilities in the heterogeneous system of Scenario 2.

FIG. 6 shows blocking probabilities in the heterogeneous system of Scenario 1.

FIG. 7 shows blocking probabilities in the heterogeneous system of Scenario 2.

Before any embodiments of the invention are explained in detail, it is to be understood that the invention is not limited in its application to the details of embodiment and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

It is disclosed a cross-layer design for coded multipath transmission in wireless networks, where MDS coding is applied to potentially utilize all paths for transmission instead of just selecting good paths based on both queue state information and channel state information. For latency-sensitive premium traffic which is required to reach the user via multiple base stations before a tight deadline, there is a tradeoff between the benefits of encoding (improving reliability) and the overhead of encoding (missing the deadline). Under the assumption of independent multiple paths, the optimal code design that minimizes the probability of packet loss can be theoretically analyzed in homogeneous systems. For general cases, load allocation strategy at multiple base stations is solved by proposing greedy-based algorithms.

Some embodiments of the invention focus on the cross-layer design of coding for multipath transmission in wireless networks, where a source node wants to transfer mission-critical premium traffic to a mobile user via the N base stations. These premium traffic packets are latency sensitive with arrival rate λ, each of which has a constant packet size L and is required to arrive at the user within a time limit T₀. Meanwhile, there are other packets, called background traffic, arriving to each base station i∈{1, . . . , N}, with rate λᵢ. If an incoming packet is blocked at a busy base station or misses the deadline, it is considered a delivery failure and the corresponding probability is called loss probability, denoted by Pₗₒₛₛ. By applying (n, k) MDS codes at the source node, each input packet is firstly divided into k sub-packets (each sub-packet is of L/k bits), and then encoded into n coded sub-packets (each also of L/k bits) assigned to all base stations. Once the user receives any k coded sub-packets within the time limit, the original packet can be successfully decoded. To minimize the loss probability, both queue state information and channel state information should be considered in code design and load allocation.

The cross-layer design for coded multipath transmission is conducted under the following assumptions:
Both premium-traffic packets and background-traffic packets arrive according to Poisson processes, and the service time of background traffic is exponential. If the background traffic accounts for the majority of the total traffic (i.e., λᵢ>>2), the premium traffic packets at different base stations are considered independent.
Each base station i is modeled as an M/G/m/m queuing system with two independent Poisson arrivals. Due to the insensitive property, the blocking probability can be calculated by Erlang B formula:

$${B}_{i} = \frac{\frac{{A}_{i}^{m}}{m !}}{{\sum }_{j = 0}^{m} \frac{{A}_{i}^{j}}{j !}} ,$$

where

$${A}_{i} = \frac{λ + {λ}_{i}}{\overline{{μ}_{l}}}$$

is the offered traffic load of base station i and

$$\frac{1}{\overline{{μ}_{l}}}$$

is the mean service time of the two traffic flows.
The values of n and k are relatively small, because sub-packets require headers for transmissions in practical implementation, and larger n and k would lead to significantly increased overhead.
The wireless link from each base station i to the user is a wireless erasure channel with constant erasure probability eᵢ and the same transmission rate R. If a sub-packet fails to be received by the user due to channel fading, the base station will retransmit it as long as the time limit T₀ is not exceeded.

The minimization of loss probability depends on the code parameters n, k and the allocation vector n≙(n₁, . . . , n_{N}), where ∥n∥₁=n≥k≥1. Since there is no closed-form formula for Pₗₒₛₛ, the joint optimization problem is hard to solve. Considering the values of n and k are generally not too large, an easy approach is to find the optimal allocation vector for each (n, k) pair, and then choose the pair with the smallest loss probability. For homogeneous systems, a uniform allocation vector, which assigns an equal number of sub-packets to each base station, must be optimal, thus greatly simplifying the joint optimization problem and leaving only the code parameters to be determined. For the general case of heterogeneous systems, the brute-force approach is adopted by first fixing the values of (n, k) and then considering the allocation subproblem.

### Code Design in Homogeneous Systems

In homogeneous systems, some embodiments of the invention use (n=N, k) MDS code and assign each of the N coded sub-packets to each base station. If λᵢ>>λ, the loss probability can be written as:

$${P}_{loss} ( k ) = {\sum }_{i = N - k + 1}^{N} ( \begin{matrix}N \\ i\end{matrix} ) {( B ( k ) + ( 1 - B ( k ) ) {q}^{k} )}^{i} {( 1 - B ( k ) - ( 1 - B ( k ) ) {q}^{k} )}^{N - i} , \qquad ( 1 )$$

$$where q = {e}_{i}^{\frac{{RT}_{0}}{L}} .$$

If the blocking probability B(k) is zero, (1) can be greatly simplified and the optimal k* that minimizes Pₗₒₛₛ(k) is at (N+1)/2 for odd N or at one of the two integers surrounding (N+1)/2 for even N. In practice, B(k) admits little variation across k due to the much more background traffic than the premium traffic. If the blocking probability is a small constant B(k)=B₀<0.1, the optimal k* shifts towards the left and can be searched over a narrowed region by using the following algorithm:

Algorithm 1 Finding the optimal k* in homogeneous systems
Input: N, q, B₀
Output: k*
1: Set k₀ := ┌log_{q}(B₀/10N)┐;
2: Find the smallest integer k₁ ≥ k₀ that satisfies
${\sum }_{i = N - k + 1}^{N} ( \begin{matrix}N \\ i\end{matrix} ) {{B}_{0}^{i} ( 1 - {B}_{0} )}^{N - i} ( {e}^{- 1.25 {Nq}^{k}} - {e}^{\frac{{Nq}^{k}}{{B}_{0}}} ) + ( \begin{matrix}N \\ N - k\end{matrix} ) {{B}_{0}^{N - k} ( 1 - {B}_{0} )}^{k} {e}^{- 1.25 {Nq}^{k}} \geq 0 ;$
3: Set k₁ := min{k₁, ┌(N + 1)/2┐};
4: Set r₀ := max{1, ┌log_{q} B₀┐ − 1} and r₀ := min{r₀, ┌0.489N + 1.8┐, ┌(N + 1)/2┐};
5: Search for k* that minimizes Pₗₒₛₛ (k) over k ∈ {r₁, r₁ + 1 , ... , k₁};

### Load Allocation in General Heterogeneous Systems

Given an (n, k) MDS code, the load allocation vector n is given by the greedy algorithm that assigns n sub-packets sequentially to the base stations in an iterative manner. In the design of the allocation algorithm, we ignore the effect of the allocation vector n on the blocking probability and approximate the blocking probability Bⱼ by a constant B̅ⱼ. First, initialize the number of sub-packets assigned to base station j, denoted by nⱼ, as zero for all j. For nᵢ≥0, define Ωᵢ(nᵢ)≙Pr{Nᵢ(nᵢ)=nᵢ} as the probability that all nᵢ assigned sub-packets are delivered successfully. At each iteration, the greedy algorithm assigns a sub-packet to base station j with the largest value of sⱼ(nⱼ), where

$${s}_{j} ( {n}_{j} ) {=}^{△} \{ \begin{matrix}( 1 - {\overline{B}}_{j} ) {Ω}_{j} ( 1 ) , & if {n}_{j} = 0 , \\ \frac{{Ω}_{j} ( {n}_{j} + 1 )}{{Ω}_{j} ( {n}_{j} )} , & if 1 \leq {n}_{j} \leq {X}_{0} , \\ 0 , & if {n}_{j} \geq {X}_{0 ,}\end{matrix} and$$

$${X}_{0} {=}^{△} min \{ k , ⌊ \frac{{kRT}_{0}}{L} ⌋ \} .$$

Suppose j* is selected, i.e.,

$${j}^{*} = arg {max}_{j} {s}_{j} ( {n}_{j} ) ,$$

with ties broken arbitrarily. Afterwards, the following update is made:

$${n}_{{j}^{*}} ← {n}_{{j}^{*}} + 1.$$

The procedure repeats until all sub-packets have been assigned, i.e., ∥n∥₁=n.

The greedy algorithm is optimal for repetition code (k=1) and uncoded scheme (n=k) with small blocking probability. For more general coding schemes, an advanced greedy+algorithm improves the assignment of last n−k sub-packets in previous greedy algorithm. The assignment of the first k sub-packets is the same as the greedy algorithm. Starting from iteration k+1, the greedy+algorithm assigns a sub-packet to base station j with the largest value of

$${s}_{j}^{+} ( n ) ,$$

where

$${s}_{j}^{+} ( n ) {=}^{△} \{ \begin{matrix}( 1 - {\overline{B}}_{j} ) {Ω}_{j} ( 1 ) Pr \{ {S}_{- j} = k - 1 \} , & if {n}_{j} = 0 , \\ {Ω}_{j} ( {n}_{j} + 1 ) Pr \{ {S}_{- j} = k - {n}_{j} - 1 \} , & if 1 \leq {n}_{j} \leq {X}_{0} , \\ 0 , & if {n}_{j} \geq {X}_{0 ,}\end{matrix}$$

and S₋ⱼ≙Σ_{i≠j}Nᵢ(nᵢ). Suppose j* is selected, i.e.,

$${j}^{*} = arg {max}_{j} {s}_{j} ( {n}_{j} ) ,$$

with ties broken arbitrarily. Afterwards, the following update is made:

$${n}_{{j}^{*}} ← {n}_{{j}^{*}} + 1.$$

The procedure repeats until all sub-packets have been assigned, i.e., ∥n∥₁=n.

Hereinafter, some embodiments of the invention will be described in detail with reference to the drawings.

### Cross-Layer Design for Coded Multipath Transmission in Wireless Networks

### I. INTRODUCTION

Low latency and high reliability requirements for some applications and services create unprecedented research challenges to wireless network design. In the fifth-generation (5G) and future sixth-generation (6G) mobile wireless networks, ultra-reliable and low-latency communications (URLLCs) plays a central role to support various emerging mission-critical applications [1]-[3]. Different approaches have been proposed to reduce transmission delay, e.g., shorter transmission time intervals (TTI) and faster uplink scheduling strategies like grant-free access [4]. Even though the physical-layer technology for 5G can achieve low transmission delay [5], the stochastic delays in upper networking layers, such as queuing delay, processing delay and packet loss, are still key bottlenecks in achieving low end-to-end delay [3]. Hence, cross-layer optimization is required [6]-[8].

In practice, data packets arrive at the buffer of the base station randomly and queue up for wireless transmission. Cross-layer design can jointly exploit the channel state information at the physical layer and queue state information at the network layer, controlling the delay and packet loss. To ensure URLLCs with finite transmit power over fading channels, both transmission delay and queuing delay are considered in the proposed cross-layer optimization framework in [9], which includes resource allocation and a proactive packet dropping policy. In [10], a cross-layer approach is proposed for time-critical applications in underwater sensor networks, combining power control with multipath routing and packet combining at the destination. In [11], a cross-layer optimization problem is investigated for indoor multiuser visible light communication (VLC) access networks, maximizing the average system throughput by optimizing the network resources under the constraints of queue stability and power. However, cross-layer models in actual systems are very complex, and the optimization problems are often non-convex or even NP-hard, leading to high computational overhead of the optimization algorithms and making it difficult to implement in actual systems [3], [8].

A promising approach to improve the latency and reliability performance of wireless communication systems is multi-connectivity (sometimes used interchangeably with another term multipath) [12], which uses multiple communication paths simultaneously. Previous works has studied multipath routing and scheduling at the network layer [13], [14] and multipath protocols (e.g., Multipath TCP) for congestion control at the transport layer [15]. However, in wireless networks, the frequently changing path characteristics bring challenges to these multipath protocols and scheduling, which require cross-layer design combining the physical layer and upper layers. Multipath routing with cross-layer approaches have been investigated in wireless sensor networks [16]-[18], which finds better routing paths by enabling cross-layer information exchange between the MAC layer and the network layer. In [19], the authors suspend/release paths based on the path quality estimated from MAC-layer information, thereby improving the management of path usage. Following works propose cross-layer path management schemes, by using the acquired knowledge of both transport layer and MAC layer, to further improve Multipath TCP [20], [21].

Instead of making decisions on path usage, some embodiments of the invention intend to use all allowed paths by applying codes. For example, if k arriving packets are encoded into n coded packets and n paths are used for transmission, the user can successfully decode the original packets from any k paths. That is, the delay of the slowest n−k path does not affect the delay of the individual packets. In fact, coding for multipath communications has been studied before [22]-[24]. For instance, in [23], linear packet-level coding is designed to minimize the packet delay under a reliability constraint in heterogeneous multipath lossy networks. The distinction is that each path is evaluated from a cross-layer perspective, combining both queue state information and channel state information for optimization. Moreover, most existing works on multipath transmission assume the paths are independent [22], [23], [25]-[27], while the present disclosure also discusses cases with dependent paths. Some embodiments of the invention consider both queue state information and channel state information in code design for multipath transmission in wireless networks. As mentioned before, cross-layer models in real systems are very complex and the associated optimization problem is often hard to solve. Hence, some embodiments of the invention give a simple cross-layer model for each path: the network layer uses a queue model to process arriving packets, and the link layer is a wireless erasure channel with constant erasure probability.

According to some embodiments of the invention, a source node transmitting latency-sensitive traffic to the user via multiple base stations is considered. The latency-sensitive traffic (called premium traffic in this disclosure) is mission-critical, and each traffic packet is required to reach the user before a tight deadline. However, packet loss can lead to unpredictable delays due to the randomness of queue states and wireless channels. To meet the delay requirement and reduce the probability of packet loss, some embodiments of the invention apply the maximum distance separable (MDS) codes at the source node and then use multiple base stations for multipath transmission. Each arriving packet is encoded into multiple coded sub-packets, which are allocated to all base stations for multipath transmission. Once the end user receives enough coded sub-packets, the original packet can be successfully decoded. In practical settings, the premium traffic is a minority compared to other background traffic, and thus the assumption of independent traffic at multiple paths is valid, simplifying the theoretical analysis of the optimal code design for homogeneous systems. For general heterogeneous cases, some embodiments of the invention focus on load allocation by evaluating the quality of each path (combing the blocking probability of the queue and the erasure probability of the channel), without the assumption of independent multipath traffic. The distinctions of this disclosure are listed as follows:
This disclosure considers coded multipath transmission with a cross-layer approach in wireless networks, including both queue state information and channel state information.
For homogeneous systems, some embodiments of the invention present theoretical analysis on the optimal code design under the assumption of independent multiple paths.
For heterogeneous systems, some embodiments of the invention propose greedy-based algorithms for load allocation without the independence assumption, which performs well as long as the system is not that homogeneous.

The rest of this disclosure is organized as follows. Section II presents the system model for coded multipath transmission and queuing model. Section III shows the optimal code design for homogeneous systems by theoretical analysis. Section IV proposes greedy algorithm and greedy+algorithm for load allocation over heterogeneous paths. Section V provides numerical results and Section VI draws the conclusion.

### II. SYSTEM MODEL

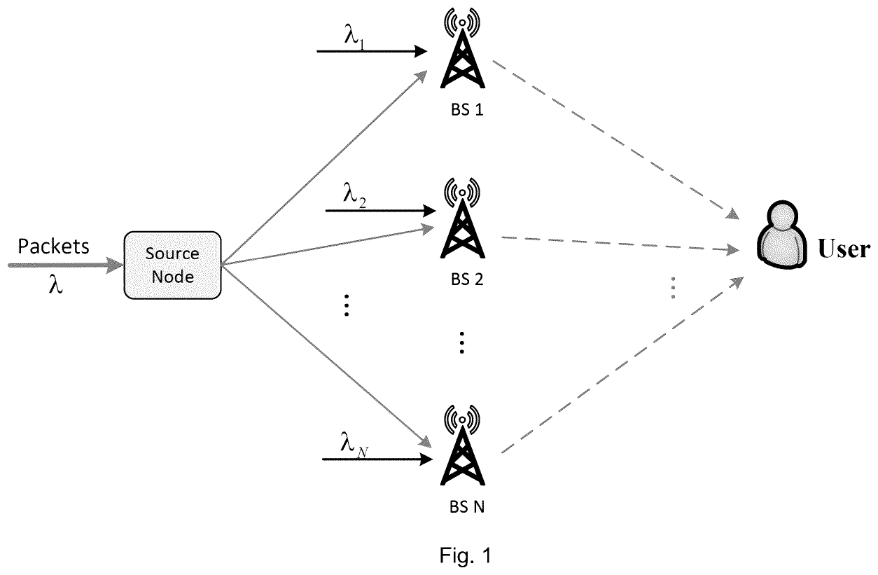

Consider a wireless network with N base stations, indexed by [symbol] ≙{1, 2, . . . , N}. There is a source node that wants to transfer some mission-critical message packets to a mobile user via the N base stations. These packets, called premium traffic, are latency sensitive with arrival rate λ, each of which has a constant packet size L and is required to arrive at the user within a time limit T₀. Once a packet misses the deadline, the packet becomes useless and is considered a delivery failure. In addition, there are other packets, called background traffic, arriving to each base station i∈ [symbol] , with rate λᵢ. These background traffic at different base stations are assumed to be independent and often account for the majority of the total traffic, i.e., λᵢ is assumed much greater than λ. An illustration is shown in FIG. 1.

Since delay is the main concern of this work, it is assumed that the base stations have no buffers. An incoming packet, if arrived at a base station that is busy, will be blocked and cleared from the system. The existence of the background traffic, therefore, impacts the service quality of the premium traffic, possibly causing a delivery failure of a premium-traffic packet. Another crucial factor is the instability of wireless connections. The user receives a distorted signal from a base station in the wireless environment and may fail to decode the message due to channel fading. Excessive retransmissions of a packet may miss the deadline.

### A. Coded Multipath Transmission

To avoid delivery failure, linear (n, k) MDS codes are applied at the source node and then N base stations are used for multipath transmission. Specifically, the source node first evenly divides an input packet into k sub-packets (each sub-packet is of L/k bits), and then encodes them into n coded sub-packets (each also of L/k bits) by using (n, k) MDS codes. Each base station i is assigned nᵢ coded sub-packets, where 0≤nᵢ≤n for all i∈ [symbol] , and [symbol] nᵢ=n. Let n≙(n₁, . . . , n_{N}) denote the allocation vector of the coded sub-packets. If a sub-packet fails to be received by the user due to the wireless erasure channel, the base station will retransmit it as long as the time limit is not exceeded. For simplicity, each base station is assumed to have the same transmission rate R, so the transmission time of each sub-packet is L/kR. Then the maximum number of transmissions for each base station is

$${X}_{max} {=}^{△} ⌊ \frac{{kRT}_{0}}{L} ⌋ .$$

Generally, the values of n and k are kept relatively small because sub-packets require headers for transmission implementation, and larger values of n and k would lead to significantly increased overhead.

Some embodiments of the invention model the link from each base station i∈ [symbol] to the user by a wireless erasure channel, where a transmitted sub-packet may be erased with probability eᵢ. To simplify the following analysis, it is assumed that for each base station, the erasure probability of each assigned sub-packet is a constant and independent of each other. This independence assumption holds when the coherence time is short, or else the base station may induce randomness by transmitting each sub-packet using, for example, frequency hopping or opportunistic beamforming [28].

If Xᵢ is a random variable following the binomial distribution with parameters Xₘₐₓ and 1−eᵢ, i.e., Xᵢ~B(Xₘₐₓ, 1−eᵢ) for all i∈ [symbol] , then the probability of getting exactly xᵢ successes in Xₘₐₓ independent Bernoulli trials (with the same success probability 1−eᵢ) is given by the probability mass function (PMF):

$$Pr \{ {X}_{i} = {x}_{i} \} = ( \begin{matrix}{X}_{max} \\ {x}_{i}\end{matrix} ) {( 1 - {e}_{i} )}^{{x}_{i}} {e}_{i}^{{X}_{max} - {x}_{i}} , \qquad ( 1 )$$

for xᵢ=0, 1, . . . , Xₘₐₓ. Let Iᵢ be a random variable that indicates whether the assigned sub-packets are blocked at base station i: 0 means blocked while 1 means unblocked. Then, the number of successfully transmitted sub-packets by base station i, denoted by ñᵢ (ñᵢ≤nᵢ), can be written as follows:

$${\tilde{n}}_{i} = {I}_{i} min \{ {n}_{i} , {X}_{i} \} {=}^{△} {I}_{i} {N}_{i} ,$$

where Nᵢ is the number of successfully delivered sub-packets by base station i on the condition that there is no blocking at base station i. It should be noted that the random variable Nᵢ is a function of nᵢ and can be expressed explicitly as Nᵢ(nᵢ) when needed. Given any nᵢ≥1, its PMF can be obtained from (1) as below:

$$Pr \{ {N}_{i} ( {n}_{i} ) = {x}_{i} \} = \{ \begin{matrix}( \begin{matrix}{X}_{max} \\ {x}_{i}\end{matrix} ) {( 1 - {e}_{i} )}^{{x}_{i}} {e}_{i}^{{X}_{max} - {x}_{i}} , & for {x}_{i} ∈ [ {n}_{i} - 1 ] , \\ {\sum }_{j = {n}_{i}}^{{X}_{max}} ( \begin{matrix}{X}_{max} \\ j\end{matrix} ) {( 1 - {e}_{i} )}^{j} {e}_{i}^{{X}_{max} - j} , & for {x}_{i} = {n}_{i} , \\ 0 , & otherwise ,\end{matrix} \qquad ( 2 )$$

where [nᵢ−1]≙{0, 1, . . . , nᵢ−1}. For example, Nᵢ(0) equals 0 with probability 1.

If the user receives at least k coded sub-packets within the time limit, i.e., Σᵢ₌₁^{N}ñᵢ≥k, the original packet can be successfully decoded due to the erasure-correction property of MDS codes [29]. Define the probability of a premium-traffic packet not being delivered to the user before the deadline as loss probability, denoted by Pₗₒₛₛ. Then, it can be written as:

$${P}_{loss} = Pr \{ {\sum }_{i = 1}^{N} {I}_{i} {N}_{i} < k \} . \qquad ( 3 )$$

The success probability, P_{succ}, is defined as 1−Pₗₒₛₛ. Note that Iᵢ and Nᵢ are independent.

### B. Queuing Model

In this subsection, some embodiments of the invention model the random variable Iᵢ that indicates the blocking of each base station i via queuing theory. No-buffer networks are considered [30], [31]. Each base station i∈ [symbol] is modeled as an m-server queuing system with two independent traffic arrivals. It is assumed that the background-traffic packets arrive at base station i following Poisson processes with parameter λᵢ with i.i.d. exponential service times of mean 1/μᵢ. The premium-traffic packets are assumed to arrive at the source node according to a Poisson process with parameter λ. As described in the previous subsection, the source node encodes each packet and sends a coded packet consisting of nᵢ sub-packets to base station i. Let Yᵢ be a negative binomial random variable (representing the total number of trials) with success probability 1−eᵢ and number of successful trials nᵢ. If there is no time limit, i.e., T₀→∞, the random service time for a coded premium-traffic packet (i.e., nᵢ sub-packets) at base station i is

$${T}_{i} {=}^{△} \frac{{Y}_{i} L}{kR} ,$$

following the negative binomial distribution scaled by the transmission time of a sub-packet.

If λᵢ is much greater than λ (this condition should hold in reality because premium traffic is expected to be much less than background traffic), an approximation can be made for the purpose of analysis, assuming that the premium traffic packets (each comprising nᵢ sub-packets) from the source node arrive at different base stations according to independent Poisson processes with the same parameter λ. This independence assumption simplifies the theoretical analysis of optimal k* in homogeneous systems in Section III, and it will be verified by computer simulations in Section V. Since the superposition of two independent Poisson processes is still a Poisson process, each base station i can be modeled as an M/G/m/m system, where the aggregation of the (coded) packets of the premium traffic and the packets of the background traffic arrives according to a Poisson process with parameter λ+λᵢ. If a packet arrives at a base station and finds all servers busy, it is blocked and cleared from the system. Otherwise, it will be modulated into radio signals and transmitted to the user by one of the idle servers. It is well known that for M/M/m/m systems, the blocking probability is insensitive to the shape of the service time distribution [32]. Hence, the blocking probability of our M/G/m/m system can be calculated by Erlang B formula:

$${B}_{i} = \frac{\frac{{A}_{i}^{m}}{m !}}{{\sum }_{j = 0}^{m} \frac{{A}_{s}^{j}}{j !}} , \qquad ( 4 )$$

$$where {A}_{i} = \frac{λ + {λ}_{i}}{{\overline{μ}}_{i}}$$

is the offered traffic load of base station i, and

$$\frac{1}{{\overline{μ}}_{i}}$$

is the mean service time, given by the weighted average service time of the two traffic flows:

$$\frac{1}{{\overline{μ}}_{i}} = \frac{λ}{λ + {λ}_{i}} E [ min \{ {T}_{0} , {T}_{i} \} ] + \frac{{λ}_{i}}{λ + {λ}_{i}} \frac{1}{{μ}_{i}} . \qquad ( 5 )$$

Here, we take the minimum between Tᵢ and T₀ because once the service time of the coded packet of the premium traffic exceeds the deadline, it will be cleared from the system. Consequently, the offered traffic load of base station i can be expressed as

$${A}_{ι} = λ E [ min \{ {T}_{0} , {T}_{i} \} ] + \frac{{λ}_{i}}{{μ}_{i}} , \qquad ( 6 )$$

which is the sum of the offered loads of the premium and background traffic, respectively.

Due to the PASTA property (Poisson Arrival Sees Time Averages), the indicator variable Iᵢ, as defined in the previous subsection, is Bernoulli distributed, taking the value 0 with probability Bᵢ. When the independence assumption holds, I₁, I₂, . . . , I_{N} can be regarded as statistically independent, implying that ñ₁, ñ₂, . . . , ñ_{N} are also independent.

### C. Problem Formulation

The goal is to minimize the loss probability, Pₗₒₛₛ, by determining the code parameters n, k and the allocation vector n. As there is no closed-form formula for Pₗₒₛₛ, the joint optimization problem is hard to solve. Since n and k are generally not too large, a possible approach is to find the optimal allocation vector for each (n, k) pair, and then choose the pair with the smallest loss probability.

For easy analysis, homogeneous systems are considered first in Section III. By symmetry, a uniform allocation vector, which assigns an equal number of sub-packets to every base station, must be optimal, thus greatly simplifying the joint optimization problem and leaving only the code parameters to be determined. For the general case of heterogeneous systems, the above brute-force approach is adopted by first fixing the values of (n, k) and then considering the allocation subproblem in Section IV.

### III. HOMOGENEOUS SYSTEMS

In this section, the special case is considered where the system is homogeneous in the sense that all base stations have the same characteristics, i.e., λᵢ=λⱼ, μᵢ=μⱼ and eᵢ=eⱼ for all i,j∈ [symbol] . Due to symmetry, the best allocation should be equal, i.e., nᵢ=nⱼ for all i,j∈ [symbol] . Given a fixed code rate of k/n, if we scale up n and k simultaneously, a premium packet will be encoded into more sub-packets, each having a smaller size. That will result in a much larger overhead due to sub-packet headers required in practical implementation. Therefore, in this section, (n=N, k) MDS code is used and each of the N coded sub-packets is assigned to each base station, such that nᵢ=1 for all i∈ [symbol] . A. In other words, once the user can receive a coded sub-packet from any k out of N base stations within the limited time T₀, the original packet can be successfully decoded.

For each base station i∈ [symbol] , the assigned coded sub-packet is blocked with probability Bᵢ. It needs to be determined how Bᵢ depends on k via (4) and (6). For simple analysis, it is assumed that

$$e {=}^{△} \frac{{RT}_{G}}{L}$$

is a positive integer so that Xₘₐₓ becomes a multiple of k, i.e., Xₘₐₓ=zk. Then,

$$min \{ {T}_{0} , {T}_{i} \} = \frac{L}{kR} min \{ {X}_{max} , {Y}_{i} \} , \qquad ( 7 )$$

where Yᵢ is geometrically distributed with success probability 1−eᵢ. According to (6), the traffic load of base station i is

$$\begin{matrix}{A}_{i} = \frac{λ L}{kR} E [ min \{ {X}_{max} , {Y}_{i} \} ] + \frac{{λ}_{i}}{{μ}_{i}} \\ = \frac{λ L}{kR} ( {\sum }_{y = 1}^{{X}_{max}} yPr \{ {Y}_{i} = y \} + {X}_{max} Pr \{ {Y}_{i} > {X}_{max} \} ) + \frac{{λ}_{i}}{{μ}_{i}} \\ = \frac{λ L}{kR} ( {\sum }_{y = 1}^{{X}_{max}} y ( 1 - {e}_{i} ) {e}_{i}^{y - 1} + {X}_{max} {e}_{i}^{{X}_{max}} ) + \frac{{λ}_{i}}{{μ}_{i}} \\ = \frac{λ L}{kR} ( \frac{1 - {e}_{i}^{{X}_{max}}}{1 - {e}_{i}} ) + \frac{{λ}_{i}}{{μ}_{i}} \\ = \frac{λ L ( 1 - {e}_{i}^{zk} )}{kR ( 1 - {e}_{i} )} + \frac{{λ}_{i}}{{μ}_{i}}\end{matrix} .$$

Accordingly, Bᵢ can be determined via the Erlang B formula in (4).

Let Pᵢ≙Pr{ñᵢ=0} be the probability that the sub-packet assigned to base station i does not arrive at the user before the deadline. Then,

$${P}_{i} = Pr \{ {I}_{i} = 0 \} + Pr \{ {I}_{i} = 1 \} Pr \{ {N}_{i} = 0 \} = {B}_{i} + ( 1 - {B}_{i} ) {e}_{i}^{zk} .$$

Since the system is homogeneous, we can drop the subscript i and make the dependence of Pᵢ and Bᵢ on k explicit by writing them as P(k) and B(k), respectively. Moreover, define

$$q {=}^{△} {e}_{i}^{z}$$

so that q^{k} is the probability that a sub-packet (of size L/k) fails to be delivered to the user. As mentioned before, for the convenience of analysis in homogeneous systems, it is assumed that the premium traffic packets from the source node arriving at different base stations are independent. Then, the loss probability can be written as

$$\begin{matrix}{P}_{loss} ( k ) = {\sum }_{i = N - k + 1}^{N} ( \begin{matrix}N \\ i\end{matrix} ) {P ( k )}^{i} {( 1 - P ( k ) )}^{N - 1} \\ = {\sum }_{i = N - k + 1}^{N} ( \begin{matrix}N \\ i\end{matrix} ) {( B ( k ) + ( 1 - B ( k ) ) {q}^{k} )}^{i} \cdot \\ {( 1 - B ( k ) - ( 1 - B ( k ) ) {q}^{k} )}^{N - i}\end{matrix} . \qquad ( 8 )$$

It should be noted that in reality, q and B(k) should be very small, which helps finding useful bounds for the optimal k* that minimizes the loss probability Pₗₒₛₛ(k). More specifically, two simpler cases are considered, namely B(k) being zero or a small constant B₀. Then, finding optimal k* in the general setting is similar.

### A. Non-Blocking Case: B(k)=0

The assumption B(k)=0 greatly simplifies the expreession of the loss probability Pₗₒₛₛ(k) to

$${\sum }_{i = N - k + 1}^{N} ( \begin{matrix}N \\ i\end{matrix} ) {( {q}^{k} )}^{i} {( 1 - {q}^{k} )}^{N - i} ,$$

which is the complementary cumulative distribution function (CDF) of B(N, q^{k}). That means, Pₗₒₛₛ(k)=Pr{X≥N−k+1} for X~B(N, q^{k}), where B stands for the binomial distribution.
Lemma 1 (Upper bound).

$${P}_{loss} ( k ) \leq ( \begin{matrix}N \\ k - 1\end{matrix} ) {q}^{k ( N - k + 1 )}$$

for all k≥1.
Proof. To count the possible combinations, it suffices to choose N−k+1 from N trials, each with probability of success q^{k}. Then the “probability” is given by

$$( \begin{matrix}N \\ N - k + 1\end{matrix} ) {q}^{k ( N - k + 1 )} ,$$

which is an upper bound due to many repeated counts. Note that

$$( \begin{matrix}N \\ N - k + 1\end{matrix} ) = ( \begin{matrix}N \\ k - 1\end{matrix} ) .$$

Lemma 2. If q<0.3, (1−q^{k})^{k-1}>0.91 for all k>1.
Proof. This is pure calculus as we investigate (1−q^{k+1})^{k} where q<0.3 and ∈ [symbol] When k=1 the expression equals 1−q²>0.91. For k≥2, note that 1−q^{k+1}>0.973. Using the fact that log(1−q)>−q/(1−q) for q∈(0, 1) we obtain the estimate

$${log ( 1 - {q}^{k + 1} )}^{k} = k log ( 1 - {q}^{k + 1} ) > \frac{- {kq}^{k + 1}}{1 - {q}^{k + 1}} > - \frac{1}{0.973} {k}^{k + 1} .$$

The function −k q^{k+1} attains minimum q(e log q)⁻¹ over positive k at k=(−log q)⁻¹. Together with q<0.3, we have

$$- \frac{1}{0.973} k {q}^{k + 1} > \frac{1}{0.973} \frac{0.3}{e log 0.3} > - 0.0942 .$$

The result follows as e^{-0.0942}>0.91.

Note that for q<0.1, (1−q^{k})^{k-1}>0.98 for all k>1. This will be used in later subsections.

Lemma 3 (Lower bound). If q<0.3,

$${P}_{loss} ( k ) \geq 0.91 ( \begin{matrix}N \\ k - 1\end{matrix} ) {q}^{k ( N - k + 1 )}$$

for all k≥1.
Proof. Pₗₒₛₛ(k) is bounded below by the i=N−k+1 term in the summation:

$${P}_{loss} ( k ) \geq ( \begin{matrix}N \\ N - k + 1\end{matrix} ) {( {q}^{k} )}^{( N - k + 1 )} {( 1 - {q}^{k} )}^{k - 1} .$$

The claim is obvious when k=1. For k>1, Lemma 2 is directly applied.
Proposition 4. If q<0.3, the optimal k* that minimizes Pₗₒₛₛ(k) is at (N+1)/2 for odd N or at one of the two integers surrounding (N+1)/2 for even N.
Proof. The proof is completed by showing that when q<0.3, Pₗₒₛₛ(k) is decreasing for k≤(N+1)/2 and is increasing for k≥(N+1)/2.

First, it is shown that if q<0.3, Pₗₒₛₛ(k−1)>Pₗₒₛₛ(k) for

$$1 < k \leq \frac{N + 1}{2} :$$

$$\frac{{P}_{loss} ( k - 1 )}{{P}_{loss} ( k )} {\geq }^{( a )} 0.91 \cdot \frac{( \begin{matrix}N \\ k - 2\end{matrix} ) {q}^{( k - 1 ) ( N - k + 2 )}}{( \begin{matrix}N \\ k - 1\end{matrix} ) {q}^{k ( N - k + 1 )}} = 0.91 \cdot \frac{k - 1}{N - k + 2} {q}^{- ( N + 2 k + 2 )} {\geq }^{( b )} 0.91 \cdot \frac{( N - 1 ) / 2}{( N + 3 ) / 2} \cdot {q}^{- 1} \geq 0.91 \cdot \frac{2}{6} \cdot {q}^{- 1} > 1 ,$$

where (a) comes from the bounds in Lemmas 1 and 3, and (b) is due to the fact that

$$\frac{k - 1}{N - k + 2} {q}^{- ( N - 2 k + 2 )}$$

is a monotonically decreasing function of k, i.e., it is minimized when k=(N+1)/2. Its decreasing property is straightforward by showing its first-order derivative is negative.

Next, it is shown that if q<0.3, Pₗₒₛₛ (k)<Pₗₒₛₛ (k+1) for

$$k \geq \frac{N + 1}{2} :$$

$$\frac{{P}_{loss} ( k )}{{P}_{loss} ( k + 1 )} \leq \frac{1}{0.91} \cdot \frac{( \begin{matrix}N \\ k - 1\end{matrix} ) {q}^{k ( N - k + 1 )}}{( \begin{matrix}N \\ k\end{matrix} ) {q}^{( k + 1 ) ( N - k )}} = \frac{1}{0.91} \cdot \frac{k}{N - k + 1} {q}^{- ( N - 2 k )} {\leq }^{( c )} \frac{1}{0.91} \cdot \frac{( N + 1 ) / 2}{( N + 1 ) / 2} \cdot q < 1 ,$$

where (c) comes from the fact that

$$\frac{k}{N - k + 1} {q}^{- ( N - 2 k )}$$

is a decreasing function of k.

### B. Constant Blocking Case: B(k)=B₀

The case where the blocking probability B(k) is a constant B₀ is useful, because in the general case B(k) admits little variation across k. This happens when the background traffic is much more than the premium traffic, which is common in reality. For convenience, it is assumed that B₀<0.1, as the blocking probability is usually not too large.

First, we derive two bounds on Pₗₒₛₛ(k), which can be used to show that Pₗₒₛₛ(k) is monotonically increasing for k≥(N+1)/2, meaning that the optimal k* must be in the interval [1, (N+1)/2], as stated in Theorem 7.

Lemma 5 (Upper bound).

$${P}_{loss} ( k ) \leq {\sum }_{i = N - k + 1}^{N} {C}_{i}^{N} {{B}_{0}^{i} ( 1 - {B}_{0} )}^{N - i} {e}^{{iq}^{k}} for all k \geq 1.$$

$$Proof .$$

$${{C}_{i}^{N} ( {B}_{0} + ( 1 - {B}_{0} ) {q}^{k} )}^{i} {( 1 - {B}_{0} - ( 1 - {B}_{0} ) {q}^{k} )}^{N - i} \leq {{C}_{i}^{N} ( {B}_{0} + {q}^{k} )}^{i} {( 1 - {B}_{0} )}^{N - i} = {C}_{i}^{N} {{B}_{0}^{i} ( 1 + \frac{{q}^{k}}{{B}_{0}} )}^{i} {( 1 - {B}_{0} )}^{N - i} {\leq }^{( a )} {C}_{i}^{N} {{B}_{0}^{i} ( 1 - {B}_{0} )}^{N - i} {e}^{\frac{{iq}^{k}}{{B}_{0}}} ,$$

where (a) is due to (1+x)^{a}≤e^{xa} for any a>0. Then the results follow by summation.
Lemma 6 (Lower bound). If q<0.1,

$${P}_{loss} ( k ) \geq {\sum }_{i = N - k + 1}^{N} {C}_{i}^{N} {{B}_{0}^{i} ( 1 - {B}_{0} )}^{N - i} {e}^{- ( N - i ) {q}^{k - 1}}$$

for all k≥1.
Proof. The proof is similar as above, except we use the fact that 1−x>e^{x/(1-x)} for x∈(0, 1):

$${{C}_{i}^{N} ( {B}_{0} + ( 1 - {B}_{0} ) {q}^{k} )}^{i} {( 1 - {B}_{0} - ( 1 - {B}_{0} ) {q}^{k} )}^{N - i} \geq {C}_{i}^{N} {{B}_{0}^{i} ( 1 - {B}_{0} - {q}^{k} )}^{N - i} = {C}_{i}^{N} {{B}_{0}^{i} ( 1 - {B}_{0} - {q}^{k} )}^{N - i} {( 1 - \frac{{q}^{k}}{1 - {B}_{0}} )}^{N - i} \geq {C}_{i}^{N} {{B}_{0}^{i} ( 1 - {B}_{0} )}^{N - i} {e}^{\frac{( N - i ) ( - {q}^{k} / ( 1 - {B}_{0} ) )}{1 - {B}_{0} - {q}^{k} / ( 1 - {B}_{0} )}} {\geq }^{( a )} {C}_{i}^{N} {{B}_{0}^{i} ( 1 - {B}_{0} )}^{N - i} {e}^{- ( N - i ) {q}^{k - 1}} ,$$

where (a) is due to 1−B₀>0.9>2q≥q^{k}+q for q, B₀<0.1.

Consider Pₗₒₛₛ(k+1)−Pₗₒₛₛ(k). By applying the lower bound to the first term and the upper to the second term, it can be shown that the difference between the two terms is bounded below by 0 when k≥(N+1)/2. The result is stated below with its proof given in Appendix A.

Theorem 7. Assume q, B₀<0.1. Given N∈ [symbol] , Pₗₒₛₛ(k) is increasing for all k>(N+1)/2.

Since k must take a value between 1 and N, Theorem 7 allows us to reduce the search space by one half. The next two propositions, whose proofs are in Appendices B and C, can further narrow down the search space.

Proposition 8. Let q, B₀<0.1. Let k₀∈ [symbol] with k₀<N. If k₀ satisfies

$${\sum }_{i = N - k + 1}^{N} {C}_{i}^{N} {{B}_{0}^{i} ( 1 - {B}_{0} )}^{N - i} ( {e}^{- {Nq}^{k}} - {e}^{\frac{{Nq}^{k}}{{B}_{0}}} ) + {e}^{- {Nq}^{k}} {C}_{N - k}^{N} {{B}_{0}^{N - k} ( 1 - {B}_{0} )}^{k} \geq 0 \qquad ( 9 )$$

and Nq^{k}/B₀<0.1 for k=k₀, then Pₗₒₛₛ(k+1)>Pₗₒₛₛ(k) for all k>k₀.
Proposition 9. Suppose q<0.1. Let 3≤r≤(N+1)/2 be an integer that satisfies B₀<q^{r} and r≤0.489N+1.9, then Pₗₒₛₛ(r−2)>Pₗₒₛₛ(r−1).

Algorithm 1 is proposed to find the optimal k* by searching over a subset of {1, 2, . . . , ┌(N+1)/2┐}, whose size can be much smaller than N/2. Its correctness is given by Propositions 8 and 9.

Algorithm 1 Finding the optimal k* in homogeneous systems

```
Input: N, q, B₀
Output: k*
  1: Set k₀ := [log_{q} (B₀/(10N))];
  2: Find the smallest integer k₁ ≥ k₀ that satisfies (9);
  3: Set k₁ := min{k₁, ┌(N + 1)/2┐;
  4: Set r₀ := max(1, ┌log_{q} B₀┐ − 1) and r₁ :=
    min(r₀, ┌0.489N + 1.9┐ , ┌(N + 1)/2┐);
  5: Search for k* that minimizes Pₗₒₛₛ(h) over k ∈
    {r₁, r₁ + 1, . . . , k₁}:
```

### IV. HETEROGENEOUS SYSTEMS

In this section, some embodiments of the invention consider the optimization of the allocation vector n given an (n, k) MDS code, where |n₁=n≥k≥1 and ∥~∥₁ denotes the l₁-norm. The blocking probability, Bᵢ, of base station i generally depends on nᵢ. In the design of the allocation algorithm, we ignore the effect of the allocation vector n on the blocking probability and approximate the blocking probability Bᵢ by a constant B̅ᵢ. This can be done by approximating the offered traffic load, Aᵢ, in (6) by a constant such as λᵢ/μᵢ (i.e., ignoring the premium traffic). Then, the loss probability expressed explicitly as a function of n, becomes

$${P}_{loss} ( n ) = Pr \{ {\sum }_{i = 1}^{N} {\overline{I}}_{i} {N}_{i} ( {n}_{i} ) < k \} , \qquad ( 10 )$$

where Īᵢ is a Bernoulli random variable which equals 0 with probability B̅ᵢ.

In the following subsections, some embodiments of the invention first propose an efficient allocation algorithm based on the greedy strategy, which is proved to be optimal for the repetition code, and also optimal for the uncoded case provided that the blocking probability is small enough. For the general coding scheme, the greedy algorithm is enhanced and the greedy+algorithm is proposed.

### A. The Greedy Algorithm

The greedy algorithm assigns n sub-packets sequentially to the base stations in an iterative manner. First, initialize the number of sub-packets assigned to base station j, denoted by nⱼ, as zero for all j∈ [symbol] . For nᵢ≥0, define Ωᵢ(nᵢ)≙Pr{Nᵢ(nᵢ)=nᵢ} as the probability that all nᵢ assigned sub-packets are delivered successfully. At each iteration, the greedy algorithm assigns a sub-packet to base station j with the largest value of sⱼ(nᵢ), where

$${s}_{j} ( {n}_{j} ) {=}^{Δ} \{ \begin{matrix}( 1 - {\overline{B}}_{j} ) {Ω}_{j} ( 1 ) & if {n}_{j} = 0 , \\ \frac{{Ω}_{j} ( {n}_{j} + 1 )}{{Ω}_{j} ( {n}_{j} )} , & if 1 \leq {n}_{j} < {X}_{0} , \\ 0 , & if {n}_{j} \geq {X}_{0} ,\end{matrix} \qquad ( 11 )$$

$$and$$

$${X}_{0} {=}^{Δ} min \{ k , {X}_{max} \} . \qquad ( 12 )$$

Suppose j* is selected, i.e., j*= [symbol] sⱼ(nⱼ), with ties broken arbitrarily. Afterwards, the following update is made:

$${n}_{{j}^{*}} ← {n}_{{j}^{*}} + 1. \qquad ( 13 )$$

The procedure repeats until all sub-packets have been assigned, i.e., ∥n∥₁=n.

To implement this algorithm, for each j∈ [symbol] , Ωⱼ(1), Ωⱼ(2), . . . Ωⱼ(k) can be pre-computed sequentially in this order. Using (2), Ωⱼ(nⱼ) can be obtained based on the value of Ωⱼ(nⱼ−1) in constant time. Therefore, to compute the k values for base station j requires O(k) time. There are N base stations, so the total time complexity is O(Nk).

For a given allocation vector n and a positive integer l≤N, we let n_{[l+]} and n_{[l-]} be the vectors obtained, respectively, by incrementing and decrementing the l-th component of n by one. It is shown that the greedy algorithm always yields an optimal solution for the repetition code (k=1) and the uncoded case (n=k) with a small enough blocking probability.

1) Special Case I: Repetition Code (k=1): When k=1, the expression for the loss probability in (10) can be simplified as

$${P}_{loss}^{( rc )} ( n ) = Pr \{ {\sum }_{i = 1}^{N} {\overline{I}}_{i} {N}_{i} ( {n}_{i} ) = 0 \} \qquad ( 14 )$$

$$= {\prod }_{i = 1}^{N} Pr \{ {\overline{I}}_{i} {N}_{i} ( {n}_{i} ) = 0 \} \qquad ( 15 )$$

$$= {\prod }_{i ∈ 𝒩 : {n}_{i} \geq 1} [ {\overline{B}}_{i} + ( 1 - {\overline{B}}_{i} ) {e}_{i}^{{X}_{max}} ] \qquad ( 16 )$$

which is defined for any n with ∥n∥₁≥1.
Proposition 10. The greedy algorithm always yields an optimal solution for the (n, 1) repetition code, n≥1.
Proof. It can be seen from (16) that assigning more than one sub-packet to a base station does not change the loss probability, i.e.,

$${P}_{loss}^{( rc )} n = {P}_{loss}^{( rc )} ( min \{ n , 1 \} ) ,$$

where the minimum is taken component-wise, and 1 is the all-one vector. Since k=1, according to (11), sⱼ=0 if nⱼ>1. Therefore, the greedy algorithm will not assign more than one sub-packet to any base station unless all base stations have sub-packets assigned. Hence, considering only the case where n≤N is enough. If n>N, after assigning the first N sub-packets to each base station, the remaining n−N sub-packets can be assigned arbitrarily.

In (11), when nⱼ=0, we have

$${s}_{j} = ( 1 - {\overline{B}}_{j} ) ( 1 - {e}_{j}^{{X}_{max}} ) .$$

Choosing the base station j with the largest sⱼ is equivalent to choosing the one with the smallest

$${\overline{B}}_{j} + ( 1 - {\overline{B}}_{j} ) {e}_{j}^{{X}_{max}} .$$

Therefore, when we need to choose n≤N base stations and assign one sub-packet to each of them, the greedy algorithm, which chooses the n base stations that have the largest values of sⱼ, gives the solution that minimizes

$${P}_{loss}^{( rc )}$$

in (16) and is thus optimal.

2) Special Case II: Uncoded Cases (n=k): When n=k, the expression for the loss probability in (10) can be further simplified as

$${P}_{loss}^{( rc )} n = 1 - \text{?} ( 1 - {\overline{B}}_{i} ) {Ω}_{i} ( {n}_{i} ) \qquad ( 17 )$$

Minimizing the above loss probability is equivalent to maximizing the success probability:

$${P}_{succ}^{( uc )} ( n ) = \text{?} ( 1 - {\overline{B}}_{i} ) {Ω}_{i} ( {n}_{i} ) \qquad ( 18 )$$

To shown the optimality, we first prove that when blocking probability is small enough such that

$${\overline{B}}_{j} \leq \frac{{e}_{j}^{{X}_{max - 1}} [ {X}_{max} ( 1 - {e}_{j} ) + {e}_{j}^{{X}_{max + 1}} - {e}_{j} ]}{{( 1 - {e}_{j}^{{X}_{max}} )}^{2}} , \qquad ( 19 )$$

the function sⱼ(nⱼ) is monotonically decreasing for any base station j∈ [symbol] . A in Lemma 11, with proof in Appendix D. Then by applying mathematical induction, it is shown that the greedy algorithm always yields an optimal solution for the uncoded cases when (19) holds.
Lemma 11. For all j∈ [symbol] , if (19) holds, then the function sⱼ(nⱼ) is monotonically decreasing, i.e., sⱼ(nⱼ)≥s(nⱼ+1), for all nⱼ≥0.
Proposition 12. If B̅ⱼ is small enough such that (19) holds for every [symbol] ,then the greedy algorithm always yields an optimal solution for the uncoded cases with n=k>1 Proof. Mathematical induction is applied. When k=1, there is only one single sub-packet. The greedy algorithm will choose the base station j that has the largest (1−B̅ⱼ)Ωⱼ(1), which clearly maximizes in (18). Therefore, P(1, 1) is true.

$${P}_{succ}^{( uc )}$$

Assume P(j, j) is true for some j≥1. Let

$${n}^{*} {=}^{△} ( {n}_{1}^{*} {…n}_{N}^{*} )$$

be an optimal solution obtained by the greedy algorithm, where ∥n*∥₁=j. Consider the case where k=j+1. Assume that the greedy algorithm assigns the (j+1)-th sub-packet to base station 1, for some l, and outputs the vector

$${n}_{[ l + ]}^{*}$$

Assume there is a vector where ∥ñ∥₁=j+1 and

$${P}_{succ}^{( uc )} ( \tilde{n} ) > {P}_{succ}^{( uc )} ( {n}_{[ l + ]}^{*} )$$

The following two cases are considered:

Case 1

$$( {\tilde{n}}_{l} > {n}_{l}^{*} )$$

It is claimed that

$${P}_{succ}^{( uc )} ( {\tilde{n}}_{[ l - ]} ) > {P}_{succ}^{( uc )} ( {n}^{*} ) ,$$

which leads to a contradiction. By (18), we have

$${P}_{succ}^{( uc )} ( {\tilde{n}}_{[ l - ]} ) = {P}_{succ}^{( uc )} ( {n}^{*} ) ( \frac{1}{{s}_{l} ( {\tilde{n}}_{l} - 1 )} ) \qquad ( 20 )$$

$$> {P}_{succ}^{( uc )} ( {n}_{[ l + ]}^{*} ) ( \frac{1}{{s}_{l} ( {\tilde{n}}_{l} - 1 )} ) \qquad ( 21 )$$

$$= {P}_{succ}^{( uc )} ( {n}^{*} ) ( \frac{{s}_{l} ( {n}_{j}^{*} )}{{s}_{l} ( {\tilde{n}}_{l} - 1 )} ) \qquad ( 22 )$$

$$\geq {P}_{succ}^{( uc )} ( {n}^{*} ) , \qquad ( 23 )$$

where (23) follows from Lemma 11.

Case 2

$$( {\tilde{n}}_{l} \leq {n}_{l}^{*} )$$

### Since

$${‖ \tilde{n} ‖}_{1} = {‖ {n}_{l +}^{*} ‖}_{1} ,$$

there must exist r∈ [symbol] \{l} such that

$${\tilde{n}}_{r} > {n}_{r}^{*} .$$

It is claimed that

$${P}_{succ}^{( uc )} ( {\tilde{n}}_{[ r - ]} ) > {P}_{succ}^{( uc )} ( {n}^{*} ) ,$$

which leads to a contradiction. By (18), we have

$$\begin{matrix}{P}_{succ}^{( uc )} ( {\tilde{n}}_{[ r - ]} ) & = & {P}_{succ}^{( uc )} ( \tilde{n} ) ( \frac{1}{{s}_{r} ( {\tilde{n}}_{r} - 1 )} ) & ( 24 ) \\ & > & {P}_{succ}^{( uc )} ( {n}_{[ l + ]}^{*} ) ( \frac{1}{{s}_{r} ( {\tilde{n}}_{r} - 1 )} ) & ( 25 ) \\ & = & {P}_{succ}^{( uc )} ( {n}^{*} ) ( \frac{{s}_{l} ( {n}_{l}^{*} )}{{s}_{r} ( {\tilde{n}}_{r} - 1 )} ) & ( 26 ) \\ & \geq & {P}_{succ}^{( uc )} ( {n}^{*} ) ( \frac{{s}_{r} ( {n}_{r}^{*} )}{{s}_{r} ( {\tilde{n}}_{r} - 1 )} ) & ( 27 ) \\ & \geq & {P}_{succ}^{( uc )} ( {n}^{*} ) , & ( 28 )\end{matrix}$$

where (27) follows from the selection criterion of the greedy algorithm, and (28) follows from Lemma 11.

Combining the two cases, it is concluded that P(j+1, j+1) is true. Hence, by mathematical induction, P(k, k) is true for all k≥1.

### B. The Greedy+Algorithm

In this subsection, the greedy algorithm in the previous subsection is improved for more general coding schemes. This new algorithm assigns the first k sub-packets in the same way as the greedy algorithm. From the (k+1)-th sub-packet onwards, a different selection rule is used.

For easy analysis, it is assumed that the blocking probability at each base station is zero, i.e., Īᵢ=1 with probability 1 for any i∈ [symbol] . Then we find a recursive formula in Lemma 13, which implies that starting from the (k+1)-th iteration, we just need to assign a sub-packet to base station j with the largest value of Ωⱼ(nⱼ+1)Pr{Σ_{i≠j}Nᵢ(nᵢ)=k−nⱼ−1} to maximize the success probability.

Lemma 13. Let n≙(n₁, . . . , n_{N}) be an arbitrary vector with ∥n∥₁>k. For any l∈ [symbol] , we have the following recursive formula:

$${P}_{succ} ( {n}_{[ l + ]} ) = {P}_{succ} ( n ) + {Ω}_{l} ( {n}_{l} + 1 ) Pr \{ {S}_{- l} = k - {n}_{l} - 1 \} , \qquad ( 29 )$$

$$where {S}_{- l} {=}^{Δ} {\sum }_{i \neq l} {N}_{i} ( {n}_{i} ) for l ∈ \text{?} .$$

Proof. Define Nₗ≙min{Nₗ(nₗ+1),nₗ}. Let E₀ be the event that Nₗ+S₋ₗ≥l; and

$${E}_{0}^{c}$$

be its complement. Furthermore, let E₁ be the event that Nₗ (nₗ+1)+S₋ₗ≥k. Intuitively, both Nₗ and Nₗ(nₗ) denote the number of successfully delivered sub-packets by base station l, but the former with nₗ+1 sub-packets assigned and the number of successfully delivered sub-packets is capped at nₗ while the latter with only nₗ sub-packets assigned. According to (2), it can be seen that the distribution of Nₗ is the same as Nₗ(nₗ), so Pr{E₀}=P_{succ}(n). Since there is no blocking, by (10), we obtain

$$\begin{matrix}{P}_{succ} ( {n}_{[ l + ]} ) & = & Pr \{ {E}_{1} \} & ( 30 ) \\ & = & Pr \{ {E}_{0} ⋂ {E}_{1} \} + Pr \{ {E}_{0}^{e} ⋂ {E}_{1} \} & ( 31 ) \\ & & & \end{matrix}$$

$$Therefore ,$$

$$\begin{matrix}{P}_{succ} ( {n}_{[ l + ]} ) - Pr \{ {E}_{0} \} & = & Pr \{ {\underline{N}}_{l} = {n}_{l} < {N}_{l} ( {n}_{l} + & ( 32 ) \\ & & 1 ) , {N}_{l} ( {n}_{l} + 1 ) \geq k - {S}_{- l} > {\underline{N}}_{l} \} & \\ & = & Pr \{ {N}_{l} ( {n}_{l} + 1 ) = {n}_{l} + 1 , k - {S}_{- l} = {n}_{l} + 1 \} & ( 33 ) \\ & = & {Ω}_{l} ( {n}_{l} + 1 ) Pr \{ {S}_{- l} = k - {n}_{l} - 1 \} & ( 34 )\end{matrix}$$

Based on the lemma above, some embodiments of the invention propose the greedy+algorithm, which still assigns the n sub-packets sequentially. As mentioned before, the assignment of the first k sub-packets is the same as the greedy algorithm. Starting from iteration k+1, the greedy+algorithm assigns a sub-packet to base station j with the largest value of

$${s}_{j}^{+} ( n ) ,$$

where

$${s}_{j}^{+} ( n ) {=}^{Δ} \{ \begin{matrix}\{ 1 - {\overline{B}}_{j} ) {Ω}_{j} ( 1 ) Pr \{ {S}_{- j} = k - 1 \} , & if {n}_{j} = 0 , \\ {Ω}_{j} ( {n}_{j} + 1 ) Pr \{ {S}_{- j} = k - {n}_{j} - 1 \} , & if 1 \leq {n}_{j} < {X}_{0} , \\ 0 , & if {n}_{j} \geq {X}_{0} .\end{matrix} \qquad ( 35 )$$

Suppose j* is selected, i.e.,

$${j}^{*} = \text{?} {s}_{j}^{+} ( n ) ,$$

with ties broken arbitrarily. Afterwards, the following update is made:

$${n}_{{j}^{*}} ← {n}_{{j}^{*}} + 1. \qquad ( 36 )$$

The procedure repeats until all sub-packets have been assigned, i.e., ∥n∥₁=n.

To implement the algorithm efficiently, dynamic programming can be used. Given an allocation vector n we need to calculate Pr{S₋ⱼ=k₀} in (35) for given values of j∈ [symbol] and k₀<k. For ease of presentation, we assume without loss of generality that j=N, so we want to calculate

$$Pr \{ {\sum }_{i = 1}^{N - 1} {N}_{i} ( {n}_{i} ) = {k}_{0} \} .$$

First, with the current value of nᵢ, we pre-compute the values of Pr{Nᵢ(nᵢ)=0}, Pr{Nᵢ(nᵢ)=1}, . . . , Pr{Nᵢ(nᵢ)=nᵢ} using (2) for all i∈ [symbol] , which can be done in time O(Nk). Next, we construct a 2D array T of size N×(k₀+1), where T[i][j] will store the probability that the sum of the first i random variables equals j. The array will be constructed as follows:
1) Initialize T[0][0]=1 and T[0][j]=0 for all j≥1.
2) For each i=1, . . . , N−1, and for each j=0, . . . , k₀, calculate

$$T [ i ] [ j ] = {\sum }_{l = 0}^{min \{ j , {n}_{i} \}} [ T [ i - 1 ] [ j - l ] \times Pr \{ {N}_{i} ( {n}_{i} ) = l \} ] \qquad ( 37 )$$

The required value of

$$Pr \{ {\sum }_{i = 1}^{N - 1} {N}_{i} ( n ) = {k}_{0} \}$$

is stored in T [N−1][k₀]. Note that the array can be constructed in time

$$O ( {N k}_{0}^{2} )$$

due to the double for-loops and the summation in (37). Therefore, the time complexity of constructing the arrays for all j∈ [symbol] is O(N²k²). As discussed in the previous subsection, the computation for Ωⱼ(nⱼ)'s for all j∈ [symbol] is O(Nk), which is dominated by the time for constructing the above arrays. Hence, the overall complexity for the greedy+algorithm is O(N²k²).

### V. SIMULATION RESULTS

In this section, some embodiments of the invention consider a wireless network with N=6 base stations, each of which is modeled as an M/G/6/6 queuing system. The background traffic packets arrive at each base station i∈ [symbol] following Poisson processes with arrival rate λᵢ, and the service time is exponential distributed with mean 1/μᵢ=e⁻³. Each of our premium traffic packets, with Poisson arrival rate λ and constant packet size L=1000 kB, is required to reach the user within the time limit T₀=LR, where R=20 Mbps is the transmission rate of each base station. In other words, each packet that takes longer than the single path transmission time (without erasure) will be dropped and considered a packet loss. To meet the delay requirement, each premium traffic packet is encoded into n shorter sub-packets via (n, k) MDS codes and sent via multipath transmissions with an allocation vector n=(n₁, . . . , n_{N}).

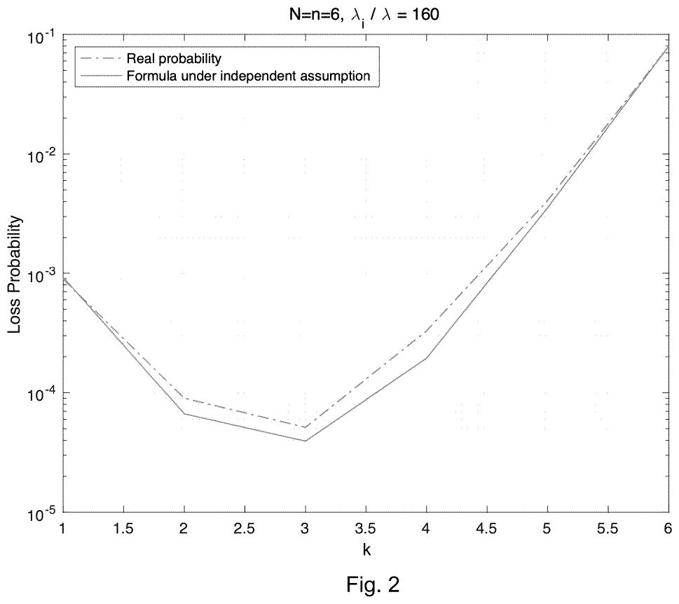

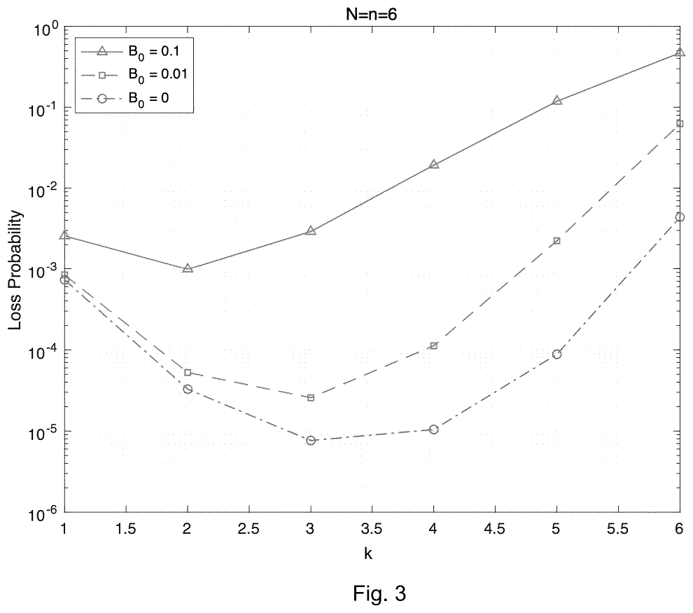

In a homogeneous system, as mentioned in Section II-A, it is assumed that the premium traffic packets arriving at different base stations from the source node are independent. This assumption is valid in reality as λᵢ is usually much larger than λ. In FIG. 2, it is shown that when channel erasure probability is eᵢ=0.3, λ=0.2 and λᵢ/λ=160, the formula for loss probability under the independence assumption as stated in (8) is close to the actual loss probability obtained by computer simulations. Hence, in FIG. 3, we use the independence assumption and compare the performance of three homogeneous systems with constant blocking probability B₀∈{0, 0.01, 0.1}. Since T₀=L/R, the maximum number of transmissions for each base station is Xₘₐₓ=k. When k increases, Xₘₐₓ becomes larger because the coding overhead decreases. The results show that when the blocking probability is zero, the optimal k*=3 that minimizes the loss probability is exactly one of the two integers surrounding (N+1)/2=3.5. When the blocking probability increases to 0.01, the optimal k* is still equal to 3, but the difference in loss probabilities between k=3 and k=4 becomes larger. When B₀=0.1, the optimal k* shifts towards the left and becomes 2. These results corroborate theoretical observations in Section III.

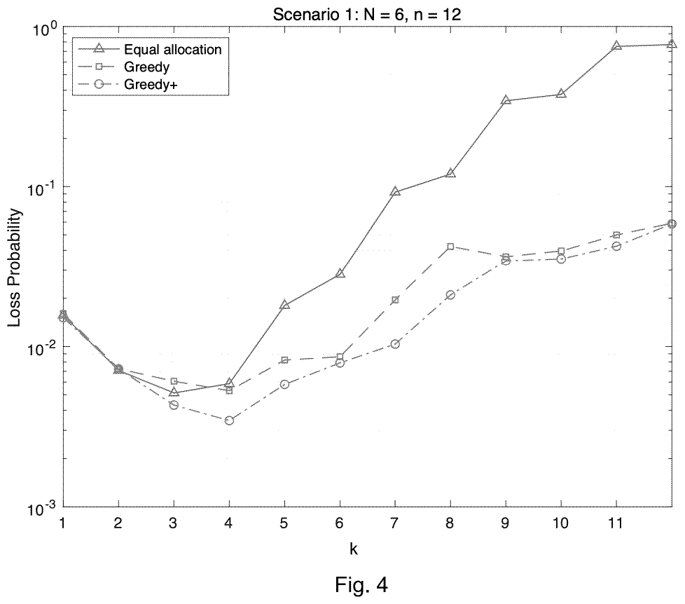

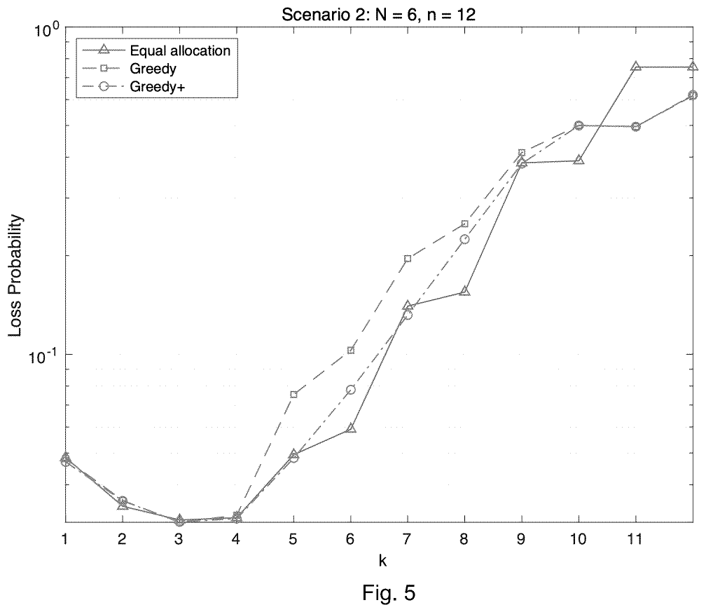

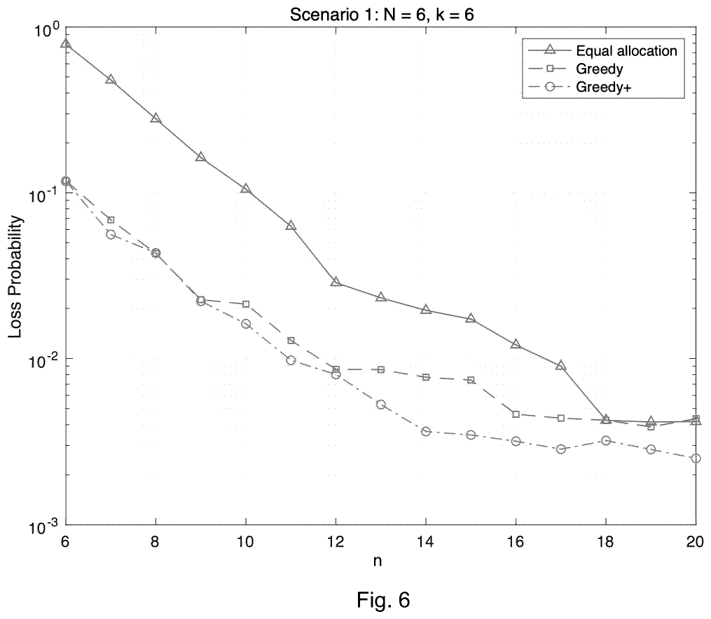

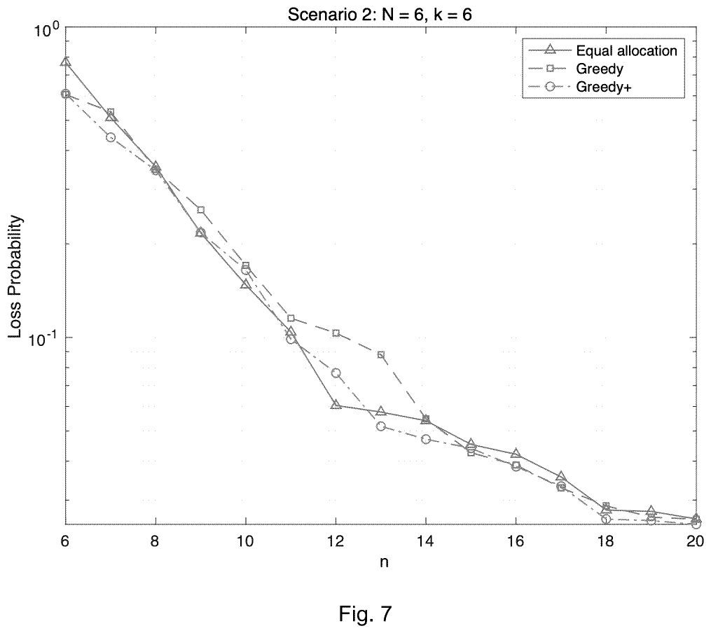

Next, two heterogeneous systems are considered, where the erasure probabilities of the wireless links, e≙(e₁, e₂, . . . , e₆) and the arrival rates of background traffic, λ≙(λ₁, λ₂, . . . , λ₆), are:
Scenario 1: e=(0.7, 0.6, 0.5, 0.4, 0.3, 0.2) and λ=20×(8, 3, 7, 6, 2, 1).
Scenario 2: e=(0.55, 0.45, 0.4, 0.5, 0.48, 0.4) and λ=20×(5, 5.8, 4, 5.2, 4.5, 5.5).
   The arrival rate of our premium traffic is λ=1. The performance of greedy algorithm and greedy+algorithm is compared with the equal allocation scheme. For the equal allocation scheme, if n is not a multiple of N, the excess (n mod N) subpackets are assigned to (n mod N) randomly selected base stations. Let n=12, and FIG. 4 shows that in Scenario 1, greedy+algorithm significantly outperforms equal allocation and is slightly better than greedy algorithm. However, when the system is less heterogeneous (in Scenario 2), FIG. 5 shows that the gap between the three schemes narrows, and equal allocation has smaller loss probability than greedy algorithm and greedy+algorithm in most cases. This is because the greedy-based algorithms are not optimal, and equal allocation has an advantage for nearly homogeneous systems. When k≤3, the user can successfully complete decoding from k sub-packets out of n=12 sub-packets, and the allocation scheme has no significant impact on the loss probability. Moreover, it can be seen that in heterogeneous systems, k being too large or too small is not good for system performance, which is the same as in homogeneous systems. The reason is that a larger k can tolerate fewer lossy paths, while a smaller k will increase the communication overhead, thus increasing the chance of missing the deadline. Let k=6, and the loss probability is plotted for k≤n≤20 under the two scenarios in FIG. 6 and FIG. 7. Greedy algorithm and greedy+algorithm significantly outperform equal allocation in Scenario 1, while their performance is similar in Scenario 2 where the system is less heterogeneous. It should be noted that although a larger value of n results in a smaller loss probability, we should not set the value of n too large as it introduces many coded subpackets, consuming much network resource.

### VI. CONCLUSION

Some embodiments of the invention propose the cross-layer design for coded multipath transmission in wireless networks. For the mission-critical traffic, each packet needs to be transmitted to the user through multiple base stations within a time limit. To reduce packet losses due to queue blocking or channel fading, (n, k) MDS code is applied to potentially utilize all paths for transmission instead of just selecting good paths based on cross-layer information. Some embodiments of the invention includes applying codes to multipath transmission for cross-layer optimization. Both theoretical analysis and numerical results show that if k is too large or too small, packet loss probability will increase, revealing the tradeoff between the benefits of encoding (improving reliability) and the overhead of encoding (missing the deadline). Moreover, the proposed greedy+algorithm outperforms equal allocation as long as the system is not that homogeneous. Future works may consider generalizing the results to more complex cross-layer designs, e.g., networks with buffers and time-varying wireless channels.

### APPENDIX A

### Proof of Theorem 7

Proof. Let X denote a random variable following the binomial distribution with success probability B₀, i.e., X~B(N, B₀) and

$$P ( X = i ) = {C}_{i}^{N} {{B}_{o}^{i} ( 1 - {B}_{0} )}^{N - 1} .$$

The theorem is proved by showing Pₗₒₛₛ(k+1)≥Pₗₒₛₛ(k) for all k∈N with N>k≥(N+1)/2 for two cases: B₀≥2Nq^{(N+1)/2} and B₀<2Nq^{(N+1)/2}.

1) Case I: B₀≥2Nq^{(N+1)/2}: According to Lemma 5 and Lemma 6, we have the following:

$${P}_{loss} ( k + 1 ) - {P}_{loss} ( k ) \geq {\sum }_{i = N - k}^{N} {C}_{i}^{N} {{B}_{o}^{i} ( 1 - {B}_{0} )}^{N - i} {e}^{- ( N - i ) {q}^{k}} - {\sum }_{i = N - k + 1}^{N} {C}_{i}^{N} {{B}_{o}^{i} ( 1 - {B}_{0} )}^{N - i} {e}^{\frac{{iq}^{k}}{{B}_{0}}} \geq {\sum }_{i = N - k + 1}^{N} {C}_{i}^{N} {{B}_{o}^{i} ( 1 - {B}_{0} )}^{N - i} {e}^{- {Nq}^{k}} - {\sum }_{i = N - k + 1}^{N} {C}_{i}^{N} {{B}_{o}^{i} ( 1 - {B}_{0} )}^{N - i} {e}^{\frac{{Nq}^{k}}{{B}_{0}}} + {e}^{- {kq}^{k}} P ( X = N - k ) = ( {e}^{- {Nq}^{k}} - {e}^{{Nq}^{k} / {B}_{0}} ) P ( X \geq N - k + 1 ) + {e}^{- {kq}^{k}} P ( X = N - k ) . \qquad ( 38 )$$

Three separate cases are considered.
1) Assume NB₀≥0.5 and k≤N(1−B₀).
In such case, we have

$$\begin{matrix}\frac{P ( X = N - k )}{P ( X = N - k + 1 )} = \frac{N - k + 1}{k} \cdot \frac{1 - {B}_{0}}{{B}_{0}} \\ \geq \frac{N - k}{{B}_{0}} \cdot \frac{1 - {B}_{0}}{k} \\ \geq \frac{N - k}{{NB}_{0}} \geq 1.\end{matrix}$$

Therefore, P (X≥N−k+1)≤kP (X=N−k). Then we have

$$( 38 ) \geq ( {e}^{- {kq}^{k}} - k ( {e}^{{Nq}^{k} / {B}_{0}} - {e}^{- {Nq}^{k}} ) ) P ( X = N - k ) .$$

Since 2NB₀≥1, 1/B₀<2N, so Nq^{k}/B₀≤2N²q^{k}. Setting k=(N+1)/2 gives

$$k ( {e}^{{Nq}^{k} / {B}_{0}} - {e}^{- {Nq}^{k}} ) \leq k ( {e}^{2 {N}^{2} {q}^{k}} - {e}^{- {Nq}^{k}} ) < \frac{N + 1}{2} ( {e}^{2 {N}^{2} {0.1}^{\frac{N + 1}{2}}} - {e}^{- N {0.1}^{\frac{N + 1}{2}}} ) < 0.8$$

by calculus, then the inequality also holds for all k≥(N+1)/2. At the same time, e^{-kq}^{^{k}}>e^{-0.1}>0.9 when q<0.1, thus Pₗₒₛₛ(k+1)−Pₗₒₛₛ(k)≥0.
2) Assume NB₀≥0.5 and k≥N(1−B₀).
In such case, we have

$$\begin{matrix}\frac{P ( X = N - k - 1 )}{P ( X = N - k )} = \frac{( N - k ) ( 1 - {B}_{0} )}{( k + 1 ) {B}_{0}} \\ \leq \frac{( N - k ) ( 1 - {B}_{0} )}{{kB}_{0}} \\ \leq \frac{N - k}{{NB}_{0}} \leq 1.\end{matrix}$$

i.e., P(X=N−k) minimizes at k=N. Therefore, P(X=N−k)>P(X=N−N)=(1−B₀)^{N}. It is continued from (38) with k>0.9N and P(X≥N−k+1)≤1:

$$\begin{matrix}( 38 ) \geq ( {e}^{- {Nq}^{k}} - {e}^{{Nq}^{k} / {B}_{0}} ) + {e}^{- {Nq}^{k}} P ( X = N - k ) \\ \geq {e}^{- {Nq}^{k}} ( {( 1 - {B}_{0} )}^{N} - ( {e}^{2.2} {N}^{2} {q}^{k} - 1 ) ) \\ \geq {e}^{- {Nq}^{k}} ( {0.9}^{N} - ( {e}^{2.2 {N}^{2} - {0.1}^{0.9 N}} - 1 ) ) .\end{matrix}$$

where 0.9^{N}−(e^{2.2N}^{²}^{·0.1}^{^{0.9N}}−1)>0 can be verified by calculus.
3) Assume NB₀≤0.5. In such case we further have

$$\begin{matrix}\frac{P ( X = N - k )}{P ( X = N - k + 1 )} = \frac{N - k + 1}{k} \cdot \frac{1 - {B}_{0}}{{B}_{0}} \\ \geq \frac{N - k + 1}{k} \cdot ( 2 N - 1 ) \\ \geq \frac{2 ( 2 N - 1 )}{( N - 1 )} \geq 4 ,\end{matrix}$$

for all k<N. By Geometric sum we have

$$\begin{matrix}P ( X \geq N - k + 1 ) \leq {\sum }_{i = 1}^{k} \frac{1}{{4}^{k}} P ( X = N - k ) \\ = ( \frac{1}{3} - \frac{1}{3 \cdot {4}^{k}} ) P ( X = N - k ) \\ \leq \frac{1}{3} P ( X = N - k ) .\end{matrix}$$

Substituting into (38) gives

$${P}_{loss} ( k + 1 ) - {P}_{loss} ( k ) \geq \frac{1}{3} P ( X = N - k ) ( 3 {e}^{- {Nq}^{k}} - ( {e}^{{Nq}^{k} / {B}_{0}} - {e}^{- {Nq}^{k}} ) ) .$$

Since B₀≥2Nq^{(N+1)/2}, one knows

$${e}^{{Nq}^{k} / {B}_{0}} \leq {e}^{0.5 {q}^{k - \frac{N + 1}{2}}} \leq {e}^{0.5} < 1.7 .$$

On the other hand, e^{-Nq}^{^{k}}>0.9 for all k, so Pₗₒₛₛ(k+1)≥Pₗₒₛₛ(k).
The claim follows by combining all three cases.

2) case I: B₀≥2Nq^{(N+1)/2}: We establish bounds like Lemma 1 and 3. Firstly notice that 2Nq^{(N+1)/4}<1, so B₀<2Nq^{(N+1)/2}<q^{(N+1)/4} From here one also obtains (1−B₀)N>(1−0.1^{(N+1)/4})^{N}>0.6.

Write 1−B₀−(1−B₀)q^{k}=(1−B₀)(1−q^{k}). Following the idea of Lemma 3 when q<0.1, (1−q^{k})^{k-1}>0.98 for all k>1. The lower bound can then be obtained by considering the last term in the summation only:

$${P}_{loss} ( k ) \geq {{C}_{N - k + 1}^{N} ( {B}_{0} + ( 1 - {B}_{0} ) {q}^{k} )}^{N - k + 1} \cdot {( 1 - {B}_{0} )}^{k - 1} {( 1 - {q}^{k} )}^{k - 1} = {{C}_{k - 1}^{N} ( \frac{{B}_{0}}{1 - {B}_{0}} + {q}^{k} )}^{N - k + 1} {( 1 - {B}_{0} )}^{N} {( 1 - {q}^{k} )}^{k - 1} \geq {{C}_{k - 1}^{N} ( {B}_{0} + {q}^{k} )}^{N - k + 1} \cdot 0.6 \cdot 0.98 > 0.5 {{C}_{k - 1}^{N} ( {B}_{0} + {q}^{k} )}^{N - k + 1} .$$

For the upper bound notice that for any k≥(N+1)/2, we have

$$\begin{matrix}\frac{{{C}_{i + 1}^{N} ( {B}_{0} + {q}^{k} )}^{i + 1}}{{{C}_{i}^{N} ( {B}_{0} + {q}^{k} )}^{i}} = \frac{N - 1}{i + 1} ( {B}_{0} + {q}^{k} ) \\ \leq \frac{N - 1}{2} ( {q}^{\frac{N + 1}{4}} + {q}^{k} ) \\ \leq \frac{N}{2} {q}^{\frac{N + 1}{4}} < 0.2 .\end{matrix}$$

Then by a geometric series,

$${\sum }_{i = N - k + 1}^{N} {{C}_{i}^{N} ( {B}_{0} + {q}^{k} )}^{i} \leq {\sum }_{i = 1}^{k} {0.2}^{i - 1} {{C}_{k - 1}^{N} ( {B}_{0} + {q}^{k} )}^{N - k + 1} \leq 1.25 {( {B}_{0} + {q}^{k} )}^{N - k + 1} .$$

### Therefore,

$$\begin{matrix}{P}_{loss} ( k ) \leq {\sum }_{i = N - k + 1}^{N} {{C}_{i}^{N} ( {B}_{0} + {q}^{k} )}^{i} \\ \leq 1.25 {{C}_{k - 1}^{N} ( {B}_{0} + {q}^{k} )}^{( N - k + 1 )} .\end{matrix}$$

Finally we combine both bounds:

$$\frac{{P}_{loss} ( k + 1 )}{{P}_{loss} ( k )} \geq \frac{0.5}{1.25} \cdot \frac{{{C}_{k}^{N} ( {B}_{0} + {q}^{k + 1} )}^{N - k}}{{{C}_{k - 1}^{N} ( {B}_{0} + {q}^{k} )}^{N - k + 1}} \cdot 0.4 \cdot \frac{N - k + 1}{k} \frac{{( {B}_{0} + {q}^{k + 1} )}^{N - k}}{{( {B}_{0} + {q}^{k} )}^{N - k + 1}} \qquad ( 39 )$$

We split into further cases to deal with the last term of (39). Write B₀=q^{r}, where

$$r \geq \frac{N + 1}{4} .$$

If r≥k:

$$\frac{{( {B}_{0} + {q}^{k + 1} )}^{N - k}}{{( {B}_{0} + {q}^{k} )}^{N - k + 1}} = \frac{{( ( q + {q}^{r - k} ) {q}^{k} )}^{N - k}}{{( ( 1 + {q}^{r - k} ) {q}^{k} )}^{N - k + 1}} \geq \frac{1}{2} \cdot {q}^{N - k} \cdot {q}^{- k} = \frac{1}{2} {q}^{- ( 2 k - N )} .$$

Since x⁻¹q^{-x}>e log(q⁻¹) for all x>0,

$$( 39 ) \geq 0.4 \cdot \frac{1}{2 k - N} \cdot \frac{1}{2} {η}^{- ( 2 k - N )} \geq 0.2 \cdot e log ( {0.1}^{- 1} ) > 1.2 .$$

If k≥r≥k−1 write B₀=wq^{k} with w∈[1, 10], then we use the fact that N−k≤k−1:

$$\frac{{( {B}_{0} + {q}^{k + 1} )}^{N - k}}{{( {B}_{0} + {q}^{k} )}^{N - k + 1}} = \frac{{( ( 0.1 + ω ) {q}^{k} )}^{N - k}}{{( ( 1 + ω ) {q}^{k} )}^{N - k + 1}} \geq {( \frac{0.1 + ω}{1 + ω} )}^{N - k} \frac{{q}^{- k}}{1 + ω} \geq \frac{10}{11} {( \frac{1}{2} )}^{k - 1} \frac{{q}^{- k}}{1 + ω} \geq {( \frac{10}{11} )}^{2} {( \frac{q}{2} )}^{- ( k - 1 )}$$

Plug the boundary case k=(N+1)/2 and the trivial assumption N>2 in gives

$$( 39 ) \geq \frac{40}{121} \cdot 1 \cdot {q}^{- ( k - 1 )} > 1.04 .$$

Finally assume k−1≥r≥(N+1)/4 then

$$\frac{{( {B}_{0} + {q}^{k + 1} )}^{N - k}}{{( {B}_{0} + {q}^{k} )}^{N - k + 1}} \geq \frac{{( {q}^{r} )}^{N - k}}{{( ( 1 + {q}^{k - r} ) {q}^{r} )}^{N - k + 1}} \geq {( 1.1 )}^{- ( N - k + 1 )} {q}^{- r} ,$$

which gives

$$( 39 ) \geq 0.4 \cdot {( 1.1 )}^{- ( N - k + 1 )} {q}^{- r} \geq 0.4 \cdot {( 1.1 )}^{- \frac{N + 1}{2}} {q}^{- \frac{N + 1}{4}} > 1$$

for all N≥1, so the claim follows.

### APPENDIX B

### Proof of Lemma 8

Proof. By induction. Suppose the above holds true for k=k₀. We assume k≤N(1−B₀) since we only care about k≤(N+1)/2, then P(X=N−k₀−1)≥P(X=N−k₀), where

$$P ( X = i ) = {C}_{i}^{N} {{B}_{0}^{i} ( 1 - {B}_{0} )}^{N - i} .$$

Since Nq^{k}/B₀<0.1, e^{Nq}^{^{k}}^{/B}^{₀}<1.12 and e^{-Nq}^{^{k}}>0.98, hence (e^{Nq}^{^{k}}^{/B}^{₀}−e^{-Nq}^{^{k}})<0.14. Combining gives

$${e}^{- {Nq}^{{k}_{0} + 1}} P ( X = N - {k}_{0} - 1 ) \geq {e}^{- {Nq}^{{k}_{0}}} \cdot P ( X = N - {k}_{0} ) \geq 0.8 ( {e}^{{Nq}^{{k}_{0}} / {B}_{0}} - {e}^{- {Nq}^{{k}_{0}}} ) P ( X \geq N - {k}_{0} + 1 ) + 0.2 {e}^{- {Nq}^{{k}_{0}}} P ( X = N - {k}_{0} ) \geq 0.8 \cdot 9.8 ( {e}^{{Nq}^{{k}_{0} + 1} / {B}_{0}} - {e}^{- {Nq}^{{k}_{0} + 1}} ) P ( X \geq N - {k}_{0} + 1 + ( {e}^{{Nq}^{{k}_{0} + 1} / {B}_{0}} - {e}^{- {Nq}^{{k}_{0} + 1}} ) P ( X = N - {k}_{0} ) \geq ( {e}^{{Nq}^{{k}_{0} + 1} / {B}_{0}} - {e}^{- {Nq}^{{k}_{0} + 1}} ) P ( X \geq N - {k}_{0} )$$

Therefore, Pₗₒₛₛ(k+1)−Pₗₒₛₛ(k)≥0 by (38).

### APPENDIX C

### Proof of Proposition 9

Proof. Note that

$$\frac{{B}_{0} + ( 1 - {B}_{0} ) {q}^{r - 2}}{{B}_{0} + ( 1 - {B}_{0} ) {q}^{r - 1}} = \frac{{q}^{r - 2} + ( 1 - {q}^{r - 2} ) {B}_{0}}{{q}^{r - 1} + ( 1 - {q}^{r - 1} ) {B}_{0}} \geq \frac{1}{1.1 q} > 9 ,$$

we know that the binomial terms in Pₗₒₛₛ(r−2) is term by term larger than that from Pₗₒₛₛ(r−1). Thus it suffices to compare the last term from Pₗₒₛₛ(r−2) against the last two terms in P(r−1):

$${P}_{loss} ( r - 2 ) - {P}_{loss} ( r - 1 ) \geq {{C}_{r - 3}^{N} ( {B}_{0} + {\overline{B}}_{0} {q}^{r - 2} )}^{N - r + 3} {{\overline{B}}_{0}^{r - 3} ( 1 - {q}^{r - 2} )}^{r - 3} - {{C}_{r - 3}^{N} ( {B}_{0} + {\overline{B}}_{0} {q}^{r - 1} )}^{N - r + 3} {{\overline{B}}_{0}^{r - 3} ( 1 - {q}^{r - 1} )}^{r - 3} - {{C}_{r - 2}^{N} ( {B}_{0} + {\overline{B}}_{0} {q}^{r - 1} )}^{N - r + 2} {{\overline{B}}_{0}^{r - 2} ( 1 - {q}^{r - 1} )}^{r - 2} \geq {{C}_{r - 3}^{N} ( {B}_{0} + {\overline{B}}_{0} {q}^{r - 1} )}^{N - r + 3} {\overline{B}}_{0}^{r - 3} \cdot ( 0.98 \cdot {( 1.1 q )}^{- ( N - r + 3 )} - 1 ) - {{C}_{r - 2}^{N} ( {B}_{0} + {\overline{B}}_{0} {q}^{r - 1} )}^{N - r + 2} {\overline{B}}_{0}^{r - 2} \cdot ( {q}^{r - 1} ( 0.98 \cdot {( 1.1 q )}^{- ( N - r + 3 )} - 1 ) - \frac{N - r + 3}{r - 2} ) \geq {{C}_{r - 3} ( {B}_{0} + {\overline{B}}_{0} {r}^{r - 1} )}^{N - r + 2} {\overline{B}}_{0}^{r - 2} \cdot ( 0.98 \cdot {1.1}^{- ( N - r + 3 )} {q}^{- ( N - 2 r + 4 )} - \frac{N + 1}{r - 2} ) ,$$

Where B̅₀≙(1−B₀) for expression simplification. The last bracket is positive if 0.98(r−2)(1.1)^{r-3}q^{2r-4}≥(N+1)(1.1q)N. By examining its asymptote, we obtain an upper bound for r as r≤0.489N+1.9, which proves the statement.

### APPENDIX D

### Proof of Lemma 11

Proof. Since the statement applies to every base station j∈ [symbol] , we drop the subscript j from sⱼ, nⱼ, Ωⱼ, and eⱼ for notation simplicity. For n≥min{k, Xₘₐₓ}−1, the statement is clearly true because s(n+1)=0≤s(n). For n=0, we have

$$\begin{matrix}s ( 0 ) - s ( 1 ) = ( 1 - \overline{B} ) Ω ( 1 ) - \frac{Ω ( 2 )}{Ω ( 1 )} & ( 40 ) \\ = \frac{( 1 - \overline{B} ) Ω ( 1 ) - Ω ( 2 )}{Ω ( 1 )} & ( 41 ) \\ = \frac{( 1 - \overline{B} ) {( 1 - {e}^{{X}_{max}} )}^{2}}{Ω ( 1 )} - \frac{( 1 - {e}^{{X}_{max}} - {X}_{max} ) ( 1 - e ) {e}^{{X}_{max} - 1} )}{Ω ( 1 )} & ( 42 )\end{matrix}$$

$$\geq 0 , \qquad ( 43 )$$

where the inequality follows from (19). For 1≤n≤min{k, Xₘₐₓ}−2,

$$\begin{matrix}s ( n ) - s ( n + 1 ) = \frac{Ω ( n + 1 )}{Ω ( n )} - \frac{Ω ( n + 2 )}{Ω ( n + 1 )} & ( 44 ) \\ = \frac{{Ω}^{2} ( n + 1 ) - Ω ( n ) Ω ( n + 2 )}{Ω ( n ) Ω ( n + 1 )} & ( 45 )\end{matrix}$$

Using (2), we can express Ωᵢ(nᵢ), for nᵢ=0, 1, . . . , Xₘₐₓ, as follows:

$${Ω}_{i} ( {n}_{i} ) = {\sum }_{j = {n}_{i}}^{{X}_{max}} {C}_{j} , \qquad ( 46 )$$

where Cⱼ represents the PMF of the binomial distribution evaluated at j, with number of trials Xₘₐₓ and success probability 1−eᵢ. Then we have

$$Ω ( n ) Ω ( n + 2 ) = ( Ω ( n + 1 ) + {C}_{n} ) ( Ω ( n + 1 ) - {C}_{n + 1} ) . \qquad ( 47 )$$

Therefore, the numerator in (45) can be written as

$$\begin{matrix}δ & {=}^{Δ} & {C}_{n} {C}_{n + 1} - ( {C}_{n} - {C}_{n + 1} ) Ω ( n + 1 ) & ( 48 ) \\ & = & {C}_{n + 1} Ω ( n + 1 ) - {C}_{n} Ω ( n + 2 ) . & ( 49 ) \\ & & & \end{matrix}$$

We want to prove that δ≥0, or equivalently,

$$\frac{Ω ( n + 2 )}{Ω ( n + 1 )} \leq \frac{{C}_{n + 1}}{{C}_{n}} = \frac{{X}_{max} - n}{n + 1} \cdot \frac{1 - e}{e} . \qquad ( 50 )$$

Note that

$$\frac{e}{1 - e} \cdot \frac{Ω ( n + 2 )}{Ω ( n + 1 )} = \frac{{\sum }_{j = n + 2}^{{X}_{max}} ( \begin{matrix}{X}_{max} \\ j\end{matrix} ) {( 1 - e )}^{j} {e}^{{X}_{max} - j}}{\frac{1 - e}{e} [ {\sum }_{j = n + 1}^{{X}_{max} - 1} ( \begin{matrix}{X}_{max} \\ j\end{matrix} ) {( 1 - e )}^{j} {e}^{{X}_{max} - j} + {( 1 - e )}^{{X}_{max}} ]} = \frac{{\sum }_{j = n + 2}^{{X}_{max}} ( \begin{matrix}{X}_{max} \\ j\end{matrix} ) {( 1 - e )}^{j} {e}^{{X}_{max} - j}}{{\sum }_{j = n + 2}^{{X}_{max}} ( \begin{matrix}{X}_{max} \\ j - 1\end{matrix} ) {( 1 - e )}^{j} {e}^{{X}_{max} - j} + {( 1 - e )}^{{X}_{max} + 1} {e}^{- 1}} \qquad ( 51 )$$

For l≥1, we have

$$\frac{( \begin{matrix}{X}_{max} \\ n + l + 1\end{matrix} )}{( \begin{matrix}{X}_{max} \\ n + l\end{matrix} )} = \frac{{X}_{max} - n - l}{n + l + 1} \leq \frac{{X}_{max} - n}{n + 1} . \qquad ( 52 )$$

Hence, each binomial coefficient,

$$( \begin{matrix}{X}_{max} \\ j\end{matrix} ) ,$$

in the numerator of (51) can be replaced by its upper bound,

$$\frac{{X}_{max} - n}{n + 1} ( \begin{matrix}{X}_{max} \\ j - 1\end{matrix} ) ,$$

to obtain

$$\begin{matrix}( 51 ) & \\ \leq \frac{{X}_{max} - n}{n + 1} \cdot \frac{{\sum }_{j = n + 2}^{{X}_{max}} ( \begin{matrix}{X}_{max} \\ j - 1\end{matrix} ) {( 1 - e )}^{j} {e}^{{X}_{max} - j}}{{\sum }_{j = n + 2}^{{X}_{max}} ( \begin{matrix}{X}_{max} \\ j - 1\end{matrix} ) {( 1 - e )}^{j} {e}^{{X}_{max} - j} + {( 1 - e )}^{{X}_{max} + 1} {e}^{- 1}} \leq \frac{{X}_{max} - n}{n + 1} , & ( 53 )\end{matrix}$$

showing that (50) holds, as desired.

### Example Features of Some Embodiments

(1) The cross-layer design of coded multipath transmission in wireless networks. One of the example features of some embodiments is using all paths by applying codes for multipath transmission while considering both queue state information and channel state information, instead of selecting the best path.

(2) The optimal code design in homogeneous systems is theoretically studied under independence assumption and efficient load allocation strategies are proposed for heterogeneous systems, providing guidance for practical cross-layer design of multipath transmission.

### Example Functions and Applications of Some Embodiments

An example function of some embodiments is to provide guidance on the cross-layer design of coded multipath transmission in wireless networks. By properly selecting code parameters and proposing efficient load allocation strategy based on the queue state information and channel state information, the packet loss probability can be reduced while satisfying the delay constraint. This is of great interest for low-latency and reliable communications in 5G and 6G.

### Example Advantages of Some Embodiments

Compared with existing technologies or works, the merits of some embodiments are:

(1) Some embodiments of the invention are based on a cross-layer perspective, considering both queue state information and channel state information, and use all paths for transmission by using codes rather than making decisions on path selection.

(2) The proposed greedy-based algorithms have low complexity.

(3) Various emerging mission-critical applications require ultra-reliable and low-latency communications (URLLCs), which will become an urgent problem to be solved in 5G and 6G mobile wireless networks. A promising approach is multipath transmission. Existing work mainly focuses on decision making on path selection through a cross-layer approach considering random delays in both the physical layer and upper networking layers. Using all paths by applying codes is more efficient.

It will be appreciated by a person skilled in the art that variations and/or modifications may be made to the described and/or illustrated embodiments of the invention to provide other embodiments of the invention. The described/or illustrated embodiments of the invention should therefore be considered in all respects as illustrative, not restrictive. Example optional features of some embodiments of the invention are provided in the summary and the description. Some embodiments of the invention may include one or more of these optional features. Some embodiments of the invention may lack one or more of these optional features.

### REFERENCES

All referenced literatures throughout this disclosure are incorporated herein by reference in their entirety, which include the following references:
[1] W. Saad, M. Bennis, and M. Chen, “A vision of 6g wireless systems: Applications, trends, technologies, and open research problems,” IEEE Network, vol. 34, no. 3, pp. 134-142, 2020.
[2] H. Lee, B. Lee, H. Yang, J. Kim, S. Kim, W. Shin, B. Shim, and H. V. Poor, “Towards 6g hyper-connectivity: Vision, challenges, and key enabling technologies,” Journal of Communications and Networks, vol. 25, no. 3, pp. 344-354, 2023.
[3] C. She, C. Sun, Z. Gu, Y. Li, C. Yang, H. V. Poor, and B. Vucetic, “A tutorial on ultrareliable and low-latency communications in 6g: Integrating domain knowledge into deep learning,” Proceedings of the IEEE, vol. 109, no. 3, pp. 204-246, 2021.
[4] M. Bennis, M. Debbah, and H. V. Poor, “Ultrareliable and low-latency wireless communication: Tail, risk, and scale,” Proceedings of the IEEE, vol. 106, no. 10, pp. 1834-1853, 2018.
[5] D. 3GPP, “Study on new radio access technology physical layer aspects,” Technical Report (TR) 38.802, V 14. 2.0, 2017.
[6] B. Fu, Y. Xiao, H. Deng, and H. Zeng, “A survey of cross-layer designs in wireless networks,” IEEE Communications Surveys & Tutorials, vol. 16, no. 1, pp. 110-126, 2014.
[7] S. Sun and S. Moon, “Practical scheduling algorithms with contiguous resource allocation for next-generation wireless systems,” IEEE Wireless Communications Letters, vol. 10, no. 4, pp. 725-729, 2021.
[8] S. He, Z. An, J. Zhu, M. Zhang, Y. Huang, and Y. Zhang, “Cross-layer optimization: Joint user scheduling and beamforming design with qos support in joint transmission networks,” IEEE Transactions on Communications, vol. 71, no. 2, pp. 792-807, 2023.
[9] C. She, C. Yang, and T. Q. S. Quek, “Cross-layer optimization for ultrareliable and low-latency radio access networks,” IEEE Transactions on Wireless Communications, vol. 17, no. 1, pp. 127-141, 2018.
[10] Z. Zhou, Z. Peng, J.-H. Cui, and Z. Shi, “Efficient multipath communication for time-critical applications in underwater acoustic sensor networks,” IEEE/ACM Transactions on Networking, vol. 19, no. 1, pp. 28-41, 2011.
[11] M. S. Demir and M. Uysal, “A cross-layer design for dynamic resource management of vlc networks,” IEEE Transactions on Communications, vol. 69, no. 3, pp. 1858-1867, 2021.
[12] M.-T. Suer, C. Thein, H. Tchouankem, and L. Wolf, “Multi-connectivity as an enabler for reliable low latency communications—an overview,” IEEE Communications Surveys & Tutorials, vol. 22, no. 1, pp. 156-169, 2020.
[13] S. K. Singh, T. Das, and A. Jukan, “A survey on internet multipath routing and provisioning,” IEEE Communications Surveys & Tutorials, vol. 17, no. 4, pp. 2157-2175, 2015.
[14] J. Qadir, A. Ali, K.-L. A. Yau, A. Sathiaseelan, and J. Crowcroft, “Exploiting the power of multiplicity: A holistic survey of networklayer multipath,” IEEE Communications Surveys & Tutorials, vol. 17, no. 4, pp. 2176-2213, 2015.
[15] C. Xu, J. Zhao, and G.-M. Muntean, “Congestion control design for multipath transport protocols: A survey,” IEEE Communications Surveys & Tutorials, vol. 18, no. 4, pp. 2948-2969, 2016.
[16] M. Abazeed, N. Faisal, and A. Ali, “Cross-layer multipath routing scheme for wireless multimedia sensor network,” Wireless Networks, vol. 25, pp. 4887-4901, 2019.
[17] S. Aswale and V. R. Ghorpade, “Geographic multipath routing based on triangle link quality metric with minimum inter-path interference for wireless multimedia sensor networks,” Journal of King Saud University—Computer and Information Sciences, vol. 33, no. 1, pp. 33-44, 2021.
[18] I. Jemili, D. Ghrab, A. Belghith, M. Mosbah, and S. Al-Ahmadi, “Cross-layer multipath approach for critical traffic in duty-cycled wireless sensor networks,” Journal of Network and Computer Applications, vol. 191, p. 103154, 2021.
[19] Y.-s. Lim, Y.-C. Chen, E. M. Nahum, D. Towsley, and K.-W. Lee, “Cross-layer path management in multi-path transport protocol for mobile devices,” in IEEE INFOCOM 2014-IEEE Conference on Computer Communications, 2014, pp. 1815-1823.
[20] Y. Cao, D. Yu, L. Zeng, Q. Liu, F. Wu, X. Gui, and M. Huang, “Towards efficient parallel multipathing: A receiver-centric cross-layer solution to aid multipath tcp,” in 2019 IEEE 25th International Conference on Parallel and Distributed Systems (ICPADS), 2019, pp. 790-797.
[21] V. S. Hapanchak and A. D. Costa, “Design and evaluation of a cross-layer mptcp path manager for vehicular networks,” in 2022 International Conference on Software, Telecommunications and Computer Networks (SoftCOM), 2022, pp. 1-6.
[22] J. Cloud and M. Medard, “Multi-path low delay network codes,” in 2016 IEEE Global Communications Conference (GLOBECOM), 2016, pp. 1-7.
[23] W. Mao, S.-p. Yeh, J. Zhu, H. Nikopour, and S. Talwar, “Delay-optimal linear packet-level coding for URLLC on multi-path wireless networks,” in 2022 IEEE 33rd Annual International Symposium on Personal, Indoor and Mobile Radio Communications (PIMRC), 2022, pp. 1171-1177.
[24] F. Gabriel, J. Acevedo, and F. H. P. Fitzek, “Network coding on wireless multipath for tactile internet with latency and resilience requirements,” in 2018 IEEE Global Communications Conference (GLOBECOM), 2018, pp. 1-6.
[25] C. Pereira, A. Aguiar, and D. E. Lucani, “Dynamic load allocation for multi-homing via coded packets,” in 2013 IEEE 77th Vehicular Technology Conference (VTC Spring), 2013, pp. 1-5.
[26] F. Chiariotti, S. Kucera, A. Zanella, and H. Claussen, “Leap: A latency control protocol for multi-path data delivery with pre-defined QoS guarantees,” in IEEE INFOCOM 2018—IEEE Conference on Computer Communications Workshops (INFOCOM WKSHPS), 2018, pp. 166-171.
[27] F. Chiariotti, S. Kucera, A. Zanella and H. Claussen, “Analysis and design of a latency control protocol for multi-path data delivery with pre-defined qos guarantees,” IEEE/ACM Transactions on Networking, vol. 27, no. 3, pp. 1165-1178, 2019.
[28] D. Tse and P. Viswanath, Fundamentals of Wireless Communication. Cambridge University Press, 2005.
[29] S. Ling and C. Xing, Coding theory: a first course. Cambridge university press, 2004.
[30] H. Yu-Pin, M. Eytan, and D. Lingjie, “Scheduling algorithms for minimizing age of information in wireless broadcast networks with random arrivals,” IEEE Transactions on Mobile Computing, vol. 19, no. 12, pp. 2903-2915, 2020.
[31] C. Guozhi, C. Yuchao, W. Jintao, and S. Jian, “Minimizing age of synchronization in no-buffer wireless networks with random arrivals,” in 2022 IEEE International Symposium on Broadband Multimedia Systems and Broadcasting (BMSB), 2022, pp. 1-5.
[32] B. A. Sevast' yanov, “An ergodic theorem for Markov processes and its application to telephone systems with refusals,” Theory of Probability & Its Applications, vol. 2, no. 1, pp. 104-112, 1957.

1. A method for multipath transmission in wireless networks, comprising:
receiving an input packet at a source node;
encoding the input packet into multiple coded sub-packets by applying codes for multipath transmission; and
transmitting the multiple coded sub-packets to a receiving end via multiple paths, wherein each path i∈{1, . . . , N}.

2. The method of claim 1, wherein the codes for multipath transmission are (n, k) maximum distance separable (MDS) codes, and the step of encoding the input packet comprises applying the (n, k) MDS codes at the source node.

3. The method of claim 2, wherein the step of encoding the input packet further comprises:
dividing the input packet into k sub-packets, wherein the input packet has a constant packet size L and each sub-packet has a packet size of L/k; and
encoding the k sub-packets into n coded sub-packets, wherein each coded sub-packet has a packet size of L/k.

4. The method of claim 3, wherein the multiple paths are multiple base stations, and the n coded sub-packets are assigned to all the base stations.

5. The method of claim 3, further comprising determining, by the receiving end that the original input packet can be successfully decoded once the receiving end receives any k coded sub-packets within a time limit T₀.

6. The method of claim 3, wherein the step of encoding the input packet further comprises code design and load allocation to minimize loss probability based on queue state information and channel state information, wherein if the input packet fails to be received by the receiving end within a time limit, it is considered a delivery failure and the corresponding probability is the loss probability.

7. The method of claim 6, wherein the code design and load allocation comprises configuring a cross-layer model for each path by using a network layer based on a queue model to process arriving packets and a link layer based on a wireless erasure channel with constant erasure probability eᵢ.

8. The method of claim 7, wherein the code design and load allocation comprises determining code parameters (n, k) for the MDS codes and allocation vector n≙(n₁, . . . , n_{N}), where ∥n∥₁=n≥k≥1 to minimize the loss probability.

9. The method of claim 8, wherein if all the paths have the same characteristics, the code design and load allocation comprises using the code parameters (n=N, k) for the MDS codes and assigning each of the N coded sub-packets to each path.

10. The method of claim 9, wherein the loss probability is provided as:
$${P}_{loss} ( k ) = {\sum }_{i = N - k + 1}^{N} ( \begin{matrix}N \\ i\end{matrix} ) {( B ( k ) + ( 1 - B ( k ) ) {q}^{k} )}^{i} {( 1 - B ( k ) - ( 1 - B ( k ) ) {q}^{k} )}^{N - i} ,$$
$$where q = {e}_{i}^{\frac{{RT}_{0}}{L}} .$$

11. The method of claim 8, wherein if all the paths do not have the same characteristics, the code design and load allocation comprises, given an (n, k) MDS code, determining load allocation vector n by greedy-based algorithm that assigns n sub-packets sequentially to the paths in an iterative manner.

12. The method of claim 11, wherein at each iteration, the greedy-based algorithm assigns a sub-packet to path j with the largest value of sⱼ(nⱼ), where
$${s}_{j} ( {n}_{j} ) {=}^{Δ} \{ \begin{matrix}\begin{matrix}( 1 - {\overline{B}}_{j} ) {Ω}_{j} ( 1 ) , & if {n}_{j} = 0 , \\ \frac{{Ω}_{j} ( {n}_{j} + 1 )}{{Ω}_{j} ( {n}_{j} )} & if 1 \leq {n}_{j} \leq {X}_{0} , \\ 0 , & if {n}_{j} \geq {X}_{0} ,\end{matrix} & \end{matrix}$$
and suppose j* is selected,
$${j}^{*} = arg {max}_{j} {s}_{j} ( {n}_{j} ) ,$$
with ties broken arbitrarily.

13. The method of claim 12, wherein the assignment of the first k sub-packets is the same as the greedy-based algorithm, and starting from iteration k+1, advanced greedy-based algorithm assigns a sub-packet to path j with the largest value of
$${s}_{j}^{+} ( n ) ,$$
where
$${s}_{j}^{+} ( n ) {=}^{Δ} \{ \begin{matrix}\begin{matrix}( 1 - {\overline{B}}_{j} ) {Ω}_{j} ( 1 ) Pr \{ {S}_{- j} = k - 1 \} , & if {n}_{j} = 0 , \\ {Ω}_{j} ( {n}_{j} + 1 ) Pr \{ {S}_{- j} = k - {n}_{j} - 1 \} , & if 1 \leq {n}_{j} \leq {X}_{0} , \\ 0 , & if {n}_{j} \geq {X}_{0} ,\end{matrix} & \end{matrix}$$
and S₋ⱼ≙Σ_{i≠j}Nᵢ(nᵢ), and suppose j* is selected,
$${j}^{*} = arg {max}_{j} {s}_{j} ( {n}_{j} ) ,$$
with ties broken arbitrarily.

14. The method of claim 12, wherein after each iteration, the following update is made:
$${n}_{{j}^{*}} ← {n}_{{j}^{*}} + 1 ,$$
and the procedure repeats until all sub-packets have been assigned.

15. A system for multipath transmission in wireless networks, comprising:
one or more processors; and
memory storing one or more programs configured to be executed by the one or more processors, the one or more programs including instructions for performing or facilitating performing of the method of claim 1.

16. A non-transitory computer-readable storage medium storing one or more programs configured to be executed by one or more processors, the one or more programs including instructions for performing or facilitating performing of the method of claim 1.
